(19) United States
(12) Patent Application Publication
(10) Pub. No.: US 2026/0341722 A1
(43) Pub. Date: Oct. 29, 2026

(54) LITHIUM-ION BATTERY ELECTRODE MATERIALS WITH GRAPHENE-CELLULOSE COMPOSITE COATINGS AND APPLICATIONS OF SAME

(71) Applicant: NORTHWESTERN UNIVERSITY, Evanston, IL (US)

(72) Inventors: Mark C. Hersam, Wilmette, IL (US); Norman S. Luu, Chicago, IL (US)

(21) Appl. No.: 19/486,135

(22) PCT Filed: May 16, 2024
(86) PCT No.: PCT/US2024/029581

§ 371 Date: Nov. 20, 2025

Related U.S. Application Data
(60) Provisional application No. 63/468,050, filed on May 22, 2023.

(51) Int. Cl. H01M 4/62; H01M 4/04; H01M 4/36; H01M 4/505; H01M 4/525

(52) U.S. Cl. CPC H01M 4/625; H01M 4/0471; H01M 4/364; H01M 4/505; H01M 4/525

(57) ABSTRACT

This invention in one aspect discloses a composite for enabling ambient stability of an electrochemical device. The composite comprises an active material, wherein individual particles and/or clusters of several particles of the active material are conformally coated with a protective barrier layer, via graphene-cellulose composite coating. The coating limits contact between atmospheric moisture and the LNO surface, which minimizes the generation of lithium impurities.

### CROSS-REFERENCE TO RELATED PATENT APPLICATIONS

This application claims priority to and the benefit of U.S. Provisional Application No. 63/468,050, filed May 22, 2023.

This application is a continuation-in-part application of U.S. application Ser. No. 18/683,549, filed Feb. 14, 2024, which is a U.S. National Phase Application of PCT Application PCT/US2022/040396, filed Aug. 16, 2022, which itself claims priority to and the benefit of U.S. Provisional Application No. 63/234,381, filed Aug. 18, 2021.

This application is a continuation-in-part application of U.S. application Ser. No. 17/713,373, filed Apr. 5, 2022, which itself claims priority to and the benefit of U.S. Provisional Application No. 63/180,301, filed Apr. 27, 2021.

This application is a continuation-in-part application of U.S. application Ser. No. 18/021,429, filed Feb. 15, 2023, which is a U.S. National Phase Application of PCT Application No. PCT/US2021/044873, filed Aug. 6, 2021, which itself claims priority to and the benefit of U.S. Provisional Application No. 63/067,948, filed Aug. 20, 2020.

Each of the above identified applications is incorporated herein in its entirety by reference.

### STATEMENT AS TO RIGHTS UNDER FEDERALLY-SPONSORED RESEARCH

This invention was made with government support under grant numbers CMMI-2037026 and DMR-1720139 awarded by the National Science Foundation. The government has certain rights in the invention.

### FIELD OF THE INVENTION

The present invention generally relates to material science, and more particularly to lithium-ion battery electrode materials with graphene-cellulose composite coatings and applications of the same.

### BACKGROUND OF THE INVENTION

The background description provided herein is to present the context of the invention generally. The subject matter discussed in the background of the invention section should not be assumed to be prior art merely due to its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Lithium-ion batteries (LIBs) are playing a key role in the societal transition towards clean energy by serving as the technology of choice to power electric vehicles and grid-level energy storage. Current and emerging engineering applications demand battery packs with increasingly higher energy densities and longer lifetimes, necessitating intelligent materials selection of electrochemically active materials. For LIB cathode materials, Ni-rich layered oxide chemistries provide a pathway to address this need since they possess intrinsically high energy densities and lifetimes that can be tuned with careful control over transition metal content and operational states of charge. Incumbent Ni-rich LIB cathode materials include LiNi_{0.8}Mn_{0.1}Co_{0.1}O₂ (NMC811), LiNi_{0.6}Mn_{0.2}Co_{0.2}Co_{0.2}O₂ (NMC622), and LiNi_{0.8}Co_{0.15}Al_{0.05}O₂ (NCA), which are isostructural to the parent compound LiNiO₂ (LNO). The addition of dopant elements in these multicomponent lithium transition metal oxides (e.g., Mn, Co, and Al) helps increase cycling longevity. Nevertheless, these materials still show instabilities that can be traced back to the chemical reactivity of Ni.

Beyond cycling stability, recent work on Ni-rich LIB cathode materials has sought to understand and mitigate their high sensitivity to ambient conditions. Ni-rich layered oxides are known to readily react with atmospheric moisture and CO₂, forming LiOH on the oxide surface. The current understanding of this ambient degradation pathway involves two mechanisms, both requiring water as a reactant. One proposed mechanism involves moisture-catalyzed transition metal reduction reactions, which are favorable due to the inherent reactivity of Ni^{3|} compared to Ni²⁺. This pathway results in partial delithiation near the surface, with lithium sequestered in hydroxide deposits. A second proposed mechanism for the formation of LiOH involves H⁺—Li⁺ site exchange upon exposure to water, which has been well-documented as a consequence of washing Ni-rich layered oxides to remove undesirable lithium residues after synthesis. After LiOH forms, it then readily reacts with ambient CO₂, forming species such as LiHCO₃ or Li₂CO₃. Lithium bicarbonates can further react with LiOH to form H₂O and Li₂CO₃ byproducts in an autocatalytic feedback loop. Following prolonged exposure to ambient conditions, where the supply of CO₂ is effectively unlimited, lithium carbonate impurities are continuously generated until the available cathode surface area is depleted of reaction sites.

Surface hydroxides and carbonates are highly undesirable since they are detrimental to both electrochemical performance and cell manufacturing. Lithium impurities reduce first-cycle capacity due to their low electronic and ionic conductivities, causing increased electrode polarization and charge transfer impedance. Furthermore, lithium carbonates on cathode surfaces promote electrolyte oxidation reactions and generate gas products during cycling, which compromise long-term cycle life. At sufficiently high concentrations, surface hydroxides and carbonates are also known to cause slurry gelation, compromising electrode coating procedures that require strict control of slurry viscosity. Therefore, these surface species are typically removed from cathode powders prior to slurry mixing using methods such as acid treatments, washing, annealing, and chemical conversion of lithium impurities.

A more attractive strategy is to inhibit the formation of surface hydroxides and carbonates altogether. Consequently, industrial facilities employ large dry rooms with tight limits on internal dew points for the storage and handling of Ni-rich LIB cathode powders. Since the operation of these dry rooms are expensive and energy-intensive, strategies for preserving high-quality cathode surfaces in ambient conditions are of high interest to ease the demand for strict environmental control. One promising approach is to utilize hydrophobic coatings that prevent direct contact between ambient moisture and Ni-rich oxide surfaces. Since the coating layer must also be electrochemically inert and transparent to lithium ions, compatible coating materials are highly limited and rarely employed in practice. To circumvent these restrictions, it would be ideal if LIB cathode surfaces could be protected with a barrier layer that could be removed on demand prior to electrochemical cycling.

### SUMMARY OF THE INVENTION

One of the objectives of this invention is to address the aforementioned deficiencies and inadequacies by coating LNO cathode particles with a hydrophobic barrier layer composed of graphene and ethyl cellulose (GrEC). This coating limits contact between atmospheric moisture and the LNO surface, which minimizes the generation of lithium impurities. This scheme is evaluated by exposing coated LNO to humidified CO₂ for 24 hours as an accelerated ambient degradation test. Subsequent spectroscopy, microscopy, and electrochemical characterization show no detectable signatures of carbonates on the LNO surface, thus verifying that the GrEC coating prevents ambient degradation. By demonstrating this methodology for the ultimate nickel-rich chemistry, this approach can likely be generalized to a wide range of ambient-sensitive battery materials.

In one aspect, this invention relates to a composite for enabling ambient stability of an electrochemical device. The composite comprises an active material, wherein individual particles and/or clusters of several particles of the active material are conformally coated with a protective barrier layer.

In one embodiment, the protective barrier layer is a uniform, hydrophobic coating.

In one embodiment, the coating comprises graphene.

In one embodiment, a mass ratio of the active material to said graphene is between about 90:5 and 99:0.5, preferably about 97.5:2.

In one embodiment, the coating further comprises multiwalled carbon nanotubes (MWCNTs).

In one embodiment, a mass ratio of said graphene to said MWCNTs is between about 5:1 and 10:1, preferably about 8:1.

In one embodiment, the coating further comprises amorphous carbon with sp²-carbon content.

In one embodiment, the amorphous carbon is an annealation product of ethyl cellulose.

In one embodiment, the coating is conformal and free of pinhole defects.

In one embodiment, the coating mitigates formation of surface carbonates and hydroxides upon a humid CO₂ exposure.

In one embodiment, the coating protects the active material from degradation during a humid CO₂ exposure and has no deleterious effects on subsequent electrochemical behavior.

In one embodiment, the active material comprises lithium cobalt oxide, lithium nickel oxide, lithium iron phosphate, lithium manganese oxide, lithium nickel manganese cobalt oxide, lithium nickel cobalt aluminum oxide, lithium-rich oxides, or a combination thereof.

In one embodiment, the active material comprises nickel-rich lithium oxides.

In one embodiment, the active material comprises LiNi_{0.8}Co_{0.15}Al_{0.05}O₂ (NCA), LiNiO₂ (LNO), LiMn_{1.5}Ni_{0.5}O₄ (LMNO), LiNiₓMn_{y}Co_{z}O₂ (NMC, where x+y+z=1), LiNi_{0.8}Co_{0.2}O₂ (LNCO), or Li_{w}NiₓMn_{y}Co_{z}O₂ (lithium-rich NMC, where w>1, x+y+z=1).

In one embodiment, the composite is substantially free of impurities.

In one embodiment, mass loss behaviors of the composite before and after a humid CO₂ exposure are substantially the same.

In one embodiment, a surface morphology of the composite during a humid CO₂ exposure is substantially same as a pristine surface morphology of the composite.

In one embodiment, electrochemical performances of the composite before and after a humid CO₂ exposure are substantially the same.

In another aspect, the invention relates to an electrode for an electrochemical device, comprising a composite including an active material, wherein individual particles of the active material are conformally coated with a protective barrier layer.

In one embodiment, the protective barrier layer is a uniform, hydrophobic coating.

In one embodiment, the coating comprises graphene.

In one embodiment, a mass ratio of the active material to said graphene is between about 90:5 and 99:0.5, preferably about 97.5:2.

In one embodiment, the coating further comprises MWCNTs.

In one embodiment, a mass ratio of said graphene to said MWCNTs is between about 5:1 and 10:1, preferably about 8:1.

In one embodiment, the coating further comprises amorphous carbon with sp²-carbon content.

In one embodiment, the amorphous carbon is an annealation product of ethyl cellulose.

In one embodiment, the coating is conformal and free of pinhole defects.

In one embodiment, the coating mitigates formation of surface carbonates and hydroxides upon a humid CO₂ exposure.

In one embodiment, the coating protects the active material from degradation during a humid CO₂ exposure and has no deleterious effects on subsequent electrochemical behavior.

In one embodiment, the active material comprises lithium cobalt oxide, lithium nickel oxide, lithium iron phosphate, lithium manganese oxide, lithium nickel manganese cobalt oxide, lithium nickel cobalt aluminum oxide, lithium-rich oxides, or a combination thereof.

In one embodiment, the active material comprises nickel-rich lithium oxides.

In one embodiment, the active material comprises NCA, LNO, LMNO, LiNiₓMn_{y}CO₂O₂ (where x+y+z=1), LNCO, or Li_{w}NiₓMn_{y}Co_{z}O₂ (lithium-rich NMC, where w>1, x+y+z=1).

In one embodiment, the active material comprises LNO.

In one embodiment, during an activation cycle, the pristine electrode exhibits no evidence of compromised electrochemical behavior, achieving a charge capacity of at least 240 mAh g⁻¹, preferably 253 mAh g⁻¹, and a discharge capacity of at least 225 mAh g⁻¹, preferably 240 mAh g⁻¹ when cycled between 2.8 V and 4.6 V vs. Li/Li⁺ at 0.1 C at 25 °C

In one embodiment, when cycled between 2.8 V and 4.6 V vs. Li/Li⁺ at 0.1 C at 25 °C, the electrode after a humid CO₂ exposure achieves a charge capacity of at least 240 mAh g⁻¹, preferably 245 mAh g⁻¹ and a discharge capacity of at least 225 mAh g⁻¹, preferably 230 mAh g⁻¹ without a discernable voltage peak at the shoulder near 3.7 V vs. Li/Li⁺.

In one embodiment, charge transfer resistances of the pristine electrode and the electrode after a humid CO₂ exposure are similar before cycling and after activation.

In one embodiment, the composite is substantially free of impurities.

In one embodiment, mass loss behaviors of the composite before and after a humid CO₂ exposure are substantially the same.

In one embodiment, a surface morphology of the composite during a humid CO₂ exposure is substantially same as a pristine surface morphology of the composite.

In one embodiment, electrochemical performances of the composite before and after a humid CO₂ exposure are substantially the same.

In yet another aspect, the invention relates to an electrochemical device, comprising the electrode as disclosed above.

In one embodiment, the electrochemical device is a battery.

In a further aspect, the invention relates to a method for forming a composite enabling ambient stability of an electrochemical device, comprising providing an active material; and coating individual particles of the active material conformally with a protective barrier layer comprising graphene.

In one embodiment, said coating comprises forming a mixture of the active material, said graphene, MWCNTs and ethyl cellulose; and thermally annealing the mixture at an annealing temperature in an oxidizing environment to decompose said ethyl cellulose, thereby resulting in the composite having each active material particle coated with a conformal coating comprising said graphene.

In one embodiment, a mass ratio of said graphene to said MWCNTs is between about 5:1 and 10:1, preferably about 8:1.

In one embodiment, the annealing temperature is in a range of about 150-350 °C, preferably at about 250 °C.

In one embodiment, the conformal coating further comprises amorphous carbon with sp²-carbon content, wherein the amorphous carbon is an annealation product of said ethyl cellulose.

In one embodiment, said forming the mixture comprises dispersing said graphene, said MWCNTs and said EC polymer in a solvent to form a first dispersion.

In one embodiment, the solvent comprises ethanol and anhydrous N-Methyl 2-pyrrolidone (NMP).

In one embodiment, a ratio of said ethanol to said graphene in the dispersion is about 2.5 to 10 mg mL⁻¹, preferably about 5 mg mL⁻¹.

In one embodiment, said forming the mixture further comprises evaporating the ethanol from the first dispersion to form a second dispersion.

In one embodiment, said forming the mixture further comprises adding the active material to the second dispersion and homogeneously incorporating the active material into the second dispersion by centrifugal mixing.

In one embodiment, a mass ratio of the active material to said graphene is between about 90:5 and 99:0.5, preferably about 97.5:2.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows LNO exposed to humid CO₂ for 24 hours exhibits severe morphological and surface chemical changes. Panels a-b: Scanning electron microscopy images of (panel a) pristine LNO and (panel b) LNO after being exposed to humid CO₂ for 24 hours. Panel c: Raman, Panel d: DRIFTS-FTIR, Panel e: XPS C 1s, and Panel f: XPS O 1s spectra show the growth of surface carbonate species after exposure to humid CO₂.

FIG. 2 shows electrochemical performance of uncoated LNO before and after humid CO₂ exposure. Panels a-b: Activation cycles of (panel a) pristine LNO and (panel b) LNO exposed to humid CO₂. Activation was performed at C/10 with a constant voltage hold at 2.8 V vs. Li/Li⁺ until the current reached C/20. The inset in (b) shows a magnified view of the voltage peak present at the initial delithiation shoulder of LNO. Panels c-d: Nyquist plots (panel c) before cycling and (panel d) after activation for pristine LNO and LNO exposed to humid CO₂.

FIG. 3 shows a hydrophobic GrEC coating protects the LNO surface from ambient degradation.

FIG. 4 shows scanning electron microscopy images show no changes in the surface morphology of the GrEC-coated LNO after 24 hours of exposure to humid CO₂. Panel a: As-coated LNO-Gr-EC, Panel b: coated LNO-Gr-EC after 24 hours of exposure to humid CO₂, Panel c: LNO-Gr obtained by pyrolyzing LNO-Gr-EC, and Panel d: LNO-Gr obtained by pyrolyzing LNO-Gr-EC after 24 hours of exposure to humid CO₂.

FIG. 5 shows LNO-Gr shows minimal evidence of degradation after 24 hours of exposure to humid CO₂. Panel a: XPS C 1s spectrum, Panel b: XPS O 1s spectrum, Panel c: Raman spectroscopy, Panel d: DRIFTS-FTIR, and Panel e: thermogravimetric analysis show that the surface impurity species on LNO-Gr do not significantly increase despite 24 hours of exposure to humid CO₂.

FIG. 6 shows electrochemical performance of LNO-Gr before and after exposure to humid CO₂ shows no discernable signatures of degradation. Panels a-b: Activation cycles of (panel a) pristine LNO-Gr and (panel b) LNO-Gr exposed to humid CO₂. Activation was performed at C/10 with a constant voltage hold at 2.8 V vs. Li/Li⁺ until the current reached C/20. The inset in panel b shows a magnified view of the initial delithiation shoulder of LNO-Gr without any voltage spike present. Panels c-d: Nyquist plots (panel c) before cycling and (panel d) after activation for pristine LNO-Gr and LNO-Gr exposed to humid CO₂.

FIG. 7 shows scanning electron microscope image of pristine LNO.

FIG. 8 shows scanning electron microscope images of LNO particles after exposure to humid CO₂ for 24 hours.

FIG. 9 shows the equivalent circuit model (Randles circuit) used to fit the impedance data.

FIG. 10 shows SEM images of the LNO-Gr sample showing a uniform graphene coating on the LNO particles. Prior to obtaining these images, ethyl cellulose was pyrolyzed at 300 °C for 1 hour in flowing O₂.

FIG. 11 shows SEM images of the LNO-Gr sample after exposure to humid CO₂ for 24 hours, showing no evidence of surface morphological changes. Prior to obtaining these images, the ethyl cellulose was pyrolyzed at 300 °C for 1 hour in flowing O₂.

FIG. 12 shows Raman spectra of the LNO-Gr-EC (top) and LNO-Gr (bottom) show a clear decrease in the D/G ratio after thermal pyrolysis of the EC at 300 °C for 1 hour in flowing O₂, thus confirming decomposition of EC.

FIG. 13 shows SEM images of LNO powder after exposure to humid CO₂ for 24 hours and subsequently heated to 300 °C for 1 hour in flowing O₂. These images show that the EC pyrolysis conditions do not remove lithium impurities from the surface of LNO.

FIG. 14 shows Raman spectrum of LNO powder after exposure to humid CO₂ for 24 hours and then heated to 300 °C for 1 hour in flowing O₂. This spectrum confirms that the EC pyrolysis conditions do not remove lithium impurities from the surface of LNO.

FIG. 15 shows XPS C 1s and O 1s spectra of LNO after exposure to humid CO₂ for 24 hours and then heated to 300 °C for 1 hour in flowing O₂. These spectra confirm that the EC pyrolysis conditions do not remove lithium impurities from the surface of LNO.

FIG. 16 shows thermogravimetric analysis of GrEC powder showing that the decomposition of residual GrEC begins below 400 °C. The Gr-EC powder here was compositionally identical to the GrEC in the LNO-Gr electrode (i.e., 1:3 Gr: EC). Prior to TGA, this GrEC powder was heated to 300 °C for 1 hour in flowing O₂ to pyrolyze the ethyl cellulose, leaving behind graphene and carbonaceous residue.

### DETAILED DESCRIPTION OF THE INVENTION

The invention will now be described more fully hereinafter with reference to the accompanying drawings, in which exemplary embodiments of the invention are shown. However, this invention may be embodied in many different forms and should not be construed as limited to the embodiments set forth herein. Rather, these embodiments are provided so that this specification will be thorough and complete and fully convey the invention's scope to those skilled in the art. Like reference numerals refer to like elements throughout.

The terms used in this specification generally have their ordinary meanings in the art, within the context of the invention, and in the specific context where each term is used. Certain terms used to describe the invention are discussed below, or elsewhere in the specification, to provide additional guidance to the practitioner regarding the description. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, or section without departing from the invention's teachings.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. Therefore, the exemplary terms “below” or “beneath” can encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Nickel-rich layered oxides are predominantly used as the cathode material of choice for high-energy lithium ion-battery cells for applications ranging from electric vehicles to stationary storage. Although these materials can provide the energy density required for high-performance applications, they suffer from similar degradation mechanisms. Beyond deterioration during electrochemical cycling, these materials are also known to degrade during storage in ambient conditions as atmospheric moisture and carbon dioxide form hydroxide and carbonate species on the particle surfaces. As a result, powders can become severely compromised in a span of days after synthesis if not handled with care.

One of the objectives of this invention is address the issues by introducing a hydrophobic coating layer composed of graphene/ethyl cellulose and demonstrates its successful application to LiNiO2 (LNO). In contrast to other layered multicomponent transition metal oxide cathodes used in electric vehicles (containing Mn, Co, and Al), LNO has the highest sensitivity to ambient conditions, making it an ideal candidate as a proof-of-concept for this technology. This scheme establishes a pathway for engineering strategies to minimize the generation of surface impurities, which is highly relevant for both incumbent and emerging ambient-reactive lithium-ion battery materials.

Specifically, the invention discloses a composite material that enables ambient stability of LNO lithium-ion battery cathode materials via graphene-cellulose composite coatings. The coating limits contact between atmospheric moisture and the LNO surface, which minimizes the generation of lithium impurities. This approach is evaluated by exposing coated LNO to humidified CO₂ for 24 hours as an accelerated ambient degradation test. Subsequent spectroscopy, microscopy, and electrochemical characterization show no detectable signatures of carbonates on the LNO surface, thus verifying that the GrEC coating prevents ambient degradation. By demonstrating this methodology for the ultimate nickel-rich chemistry, this approach can likely be generalized to a wide range of ambient-sensitive battery electrode materials. This graphene coating is easily processable, based on low-cost carbon, and can be generally applied to enhance the electrochemical performance across the library of battery electrode materials. The coating is also electrically conductive, making it advantageous over incumbent coating technologies based on other hydrophobic layers, which possess low electrical conductivity.

The invention has, among other things, at least the following advantages over the prior art.

On the industrial scale, long-term storage of Li-ion battery cathode powders requires strict humidity control and is often accomplished with large dry rooms with tight limits on internal dew points. Operating and maintaining these dry rooms can be highly expensive.

The method disclosed in the invention for preserving high-quality cathode surfaces in ambient conditions can significantly ease the demand for strict environmental control.

Other methods to address humidity- or ambient-induced degradation include compositional changes (e.g., Zr doping, W doping, Al doping, Mg and Ti doping, etc.).

These compositional changes are difficult to implement at the industrial scale since they require that cathode material manufacturers alter the material chemistry during synthesis. In contrast, a secondary coating layer can be applied to powders in a chemistry-agnostic manner, which is a more realistic solution from a supply chain perspective. Other secondary coating methods include polydimethylsiloxane (PDMS), which has been demonstrated as a secondary material that remains in the electrode after fabrication procedures. In addition to its poor electrical conductivity, the presence of PDMS in the electrode is not well studied and may have long term implications for cyclic stability. On the other hand, the technology disclosed in this invention removes the hydrophobic component prior to electrode fabrication, leaving behind graphene in the electrode architecture. Graphene is well-known to impart superlative electrical conductivity and cyclic stability across several battery chemistries, including Ni-rich layered oxide cathodes.

The invention can have widespread applications in the fields of Li-ion batteries, graphene coating or graphene encapsulation, cathode materials, ambient stability, ambient storage, mitigating ambient degradation, conductive additives, intercalation materials, and/or mitigating chemomechanical degradation.

Without intent to limit the scope of the invention, exemplary embodiments of the invention are given below.

In one aspect, this invention relates to a composite for enabling ambient stability of an electrochemical device. The composite comprises an active material, wherein individual particles and/or clusters of several particles of the active material are conformally coated with a protective barrier layer.

In one embodiment, the protective barrier layer is a uniform, hydrophobic coating.

In one embodiment, the coating comprises graphene.

In one embodiment, a mass ratio of the active material to said graphene is between about 90:5 and 99:0.5, preferably about 97.5:2.

In one embodiment, the coating further comprises multiwalled carbon nanotubes (MWCNTs).

In one embodiment, a mass ratio of said graphene to said MWCNTs is between about 5:1 and 10:1, preferably about 8:1.

In one embodiment, the coating further comprises amorphous carbon with sp²-carbon content.

In one embodiment, the amorphous carbon is an annealation product of ethyl cellulose.

In one embodiment, the coating is conformal and free of pinhole defects.

In one embodiment, the coating mitigates formation of surface carbonates and hydroxides upon a humid CO₂ exposure.

In one embodiment, the coating protects the active material from degradation during a humid CO₂ exposure and has no deleterious effects on subsequent electrochemical behavior.

In one embodiment, the active material comprises lithium cobalt oxide, lithium nickel oxide, lithium iron phosphate, lithium manganese oxide, lithium nickel manganese cobalt oxide, lithium nickel cobalt aluminum oxide, lithium-rich oxides, or a combination thereof.

In one embodiment, the active material comprises nickel-rich lithium oxides.

In one embodiment, the active material comprises LiNi_{0.8}Co_{0.15}Al_{0.05}O₂ (NCA), LiNiO₂ (LNO), LiMn_{1.5}Ni_{0.5}O₄ (LMNO), LiNiₓMn_{y}CO₂O₂ (NMC, where x+y+z=1), LiNi_{0.8}Co_{0.2}O₂ (LNCO), or Liw NiₓMn_{y}CO₂O₂ (lithium-rich NMC, where w>1, x+y+z=1).

In one embodiment, the composite is substantially free of impurities.

In one embodiment, mass loss behaviors of the composite before and after a humid CO₂ exposure are substantially the same.

In one embodiment, a surface morphology of the composite during a humid CO₂ exposure is substantially same as a pristine surface morphology of the composite.

In one embodiment, electrochemical performances of the composite before and after a humid CO₂ exposure are substantially the same.

In another aspect, the invention relates to an electrode for an electrochemical device, comprising a composite including an active material, wherein individual particles of the active material are conformally coated with a protective barrier layer.

In one embodiment, the protective barrier layer is a uniform, hydrophobic coating.

In one embodiment, the coating comprises graphene.

In one embodiment, a mass ratio of the active material to said graphene is between about 90:5 and 99:0.5, preferably about 97.5:2.

In one embodiment, the coating further comprises multiwalled carbon nanotubes (MWCNTs).

In one embodiment, a mass ratio of said graphene to said MWCNTs is between about 5:1 and 10:1, preferably about 8:1.

In one embodiment, the coating further comprises amorphous carbon with sp²-carbon content.

In one embodiment, the amorphous carbon is an annealation product of ethyl cellulose.

In one embodiment, the coating is conformal and free of pinhole defects.

In one embodiment, the coating mitigates formation of surface carbonates and hydroxides upon a humid CO₂ exposure.

In one embodiment, the coating protects the active material from degradation during a humid CO₂ exposure and has no deleterious effects on subsequent electrochemical behavior.

In one embodiment, the active material comprises lithium cobalt oxide, lithium nickel oxide, lithium iron phosphate, lithium manganese oxide, lithium nickel manganese cobalt oxide, lithium nickel cobalt aluminum oxide, lithium-rich oxides, or a combination thereof.

In one embodiment, the active material comprises nickel-rich lithium oxides.

In one embodiment, the active material comprises LiNi_{0.8}Co_{0.15}Al_{0.05}O₂ (NCA), LiNiO₂ (LNO), LiMn_{1.5}Ni_{0.5}O₄ (LMNO), LiNiₓMn_{y}Co_{z}O₂ (NMC, where x+y+z=1), LiNi_{0.8}Co_{0.2}O₂ (LNCO), or Li_{w}NiₓMn_{y}Co_{z}O₂ (lithium-rich NMC, where w>1, x+y+z=1).

In one embodiment, the active material comprises LNO.

In one embodiment, during an activation cycle, the pristine electrode exhibits no evidence of compromised electrochemical behavior, achieving a charge capacity of at least 240 mAh g⁻¹, preferably 253 mAh g⁻¹ and a discharge capacity of at least 225 mAh g⁻¹, preferably 240 mAh g⁻¹ when cycled between 2.8 V and 4.6 V vs. Li/Li⁺ at 0.1 C at 25 °C.

In one embodiment, when cycled between 2.8 V and 4.6 V vs. Li/Li⁺ at 0.1 C at 25 °C, the electrode after a humid CO₂ exposure achieves a charge capacity of at least 240 mAh g⁻¹, preferably 245 mAh g⁻¹ and a discharge capacity of at least 225 mAh g⁻¹, preferably 230 mAh g⁻¹, without a discernable voltage peak at the shoulder near 3.7 V vs. Li/Li⁺.

In one embodiment, charge transfer resistances of the pristine electrode and the electrode after a humid CO₂ exposure are similar before cycling and after activation.

In one embodiment, the composite is substantially free of impurities.

In one embodiment, mass loss behaviors of the composite before and after a humid CO₂ exposure are substantially the same.

In one embodiment, a surface morphology of the composite during a humid CO₂ exposure is substantially same as a pristine surface morphology of the composite.

In one embodiment, electrochemical performances of the composite before and after a humid CO₂ exposure are substantially the same.

In yet another aspect, the invention relates to an electrochemical device, comprising the electrode as disclosed above.

In one embodiment, the electrochemical device is a battery.

In a further aspect, the invention relates to a method for forming a composite enabling ambient stability of an electrochemical device, comprising: providing an active material; and coating individual particles of the active material conformally with a protective barrier layer comprising graphene.

In one embodiment, said coating comprises forming a mixture of the active material, said graphene, multiwalled carbon nanotubes (MWCNTs) and ethyl cellulose; and thermally annealing the mixture at an annealing temperature in an oxidizing environment to decompose said ethyl cellulose, thereby resulting in the composite having each active material particle coated with a conformal coating comprising said graphene.

In one embodiment, a mass ratio of said graphene to said MWCNTs is between about 5:1 and 10:1, preferably about 8:1.

In one embodiment, the annealing temperature is in a range of about 150-350 °C, preferably at about 250 °C

In one embodiment, the conformal coating further comprises amorphous carbon with sp²-carbon content, wherein the amorphous carbon is an annealation product of said ethyl cellulose.

In one embodiment, said forming the mixture comprises dispersing said graphene, said MWCNTs and said EC polymer in a solvent to form a first dispersion.

In one embodiment, the solvent comprises ethanol and anhydrous N-Methyl 2-pyrrolidone (NMP).

In one embodiment, a ratio of said ethanol to said graphene in the dispersion is about 2.5 to 10 mg mL⁻¹, preferably about 5 mg mL⁻¹.

In one embodiment, said forming the mixture further comprises evaporating the ethanol from the first dispersion to form a second dispersion.

In one embodiment, said forming the mixture further comprises adding the active material to the second dispersion and homogeneously incorporating the active material into the second dispersion by centrifugal mixing.

In one embodiment, a mass ratio of the active material to said graphene is between about 90:5 and 99:0.5, preferably about 97.5:2.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### Enabling Ambient Stability of LiNiO₂ Lithium-Ion Battery Cathode Materials Via Graphene-Cellulose Composite Coatings

Nickel-rich layered oxides are widely used as cathode materials for energy-dense lithium-ion batteries. These chemistries, based on the parent compound LiNiO₂ (LNO), are highly sensitive to ambient environments and are known to readily react with moisture and carbon dioxide. As a result, impurities such as lithium hydroxides and lithium carbonates are formed at the LNO surface, compromising electrochemical behavior.

In this exemplary study, we address the aforementioned issues of ambient-reactive Ni-rich layered oxides via a hydrophobic coating layer composed of graphene and ethyl cellulose (GrEC). We demonstrate this scheme for LNO since it represents the Ni-rich limit with the highest ambient sensitivity in the family of Ni-rich layered oxides. Ethyl cellulose (EC) is an attractive materials choice since it is hydrophobic and can be scalably coated onto cathode material surfaces via solution-phase methods. EC can also be pyrolyzed thermally or photonically, enabling its removal immediately preceding electrochemical cycling. Notably, when this pyrolysis occurs in the presence of graphene, EC is known to decompose into low molecular weight aromatic carbon products, yielding carbonaceous residues with high sp² content that improves charge transport. GrEC coatings therefore enable both long-term ambient storage and exceptional electrochemical performance for Ni-rich LIB cathode powders.

### Materials and Experimental Methods

LNO Synthesis: LNO powder was synthesized at the Argonne National Laboratory (ANL) Materials Engineering Research Facility (MERF) using a procedure that was slightly modified from previous reports. In particular, Ni(OH)₂ precursor powders were synthesized continuously in a 10 L Taylor Vortex Reactor (TVR) via the hydroxide co-precipitation method using NiSO₄·6H₂O as the starting material. Nickel sulfate salts were first dissolved in nitrogen-purged deionized water to obtain a 2 M solution. A 4 M solution of NaOH was employed as a co-precipitating agent, while the chelating agent was 4 M NH₄OH. The pH and temperature of the solution inside the reactor were maintained at 11.8 (±0.02) and 50 °C (=0.2 °C), respectively. The reactor was filled with nitrogen-purged deionized water before pumping in the reactants, and the inner cylinder was rotated at 900 RPM to create a Taylor vortex flow pattern inside the gap between two concentric cylinders where the reaction proceeded. The nickel sulfate solution was fed at about 17 mL min⁻¹, and NH₄OH was introduced at about 8.5 mL min⁻¹. The NaOH flow was adjusted to maintain the pH of the solution. The final precursor powder was produced continuously with a yield of about 170 g h⁻¹. The precipitated product was washed thoroughly with nitrogen-purged deionized water until the conductivity of the solution was below 20 μS cm⁻¹. The washed powder was then dried overnight at 120 °C under vacuum to obtain the hydroxide precursor with a tap density of 1.94 g cm⁻³ and particle size (D50) of 9.36 μm. The final LNO powder was obtained after calcination with LiOH at 665 °C for 12 h with a heating ramp of 2 °C min¹ under O₂ atmosphere in a modified box furnace. The LNO powder had a final tap density of 2.31 g cm⁻³ and particle size (D50) of 9.66 μm. Prior to use, LNO powders were subjected to a low-temperature thermal cleaning process at 250 °C for 1 h under flowing oxygen to remove weakly adsorbed impurity species. The ramp rate used for this step was 5 °C min⁻¹. After cooling, the cleaned LNO powder was then immediately moved into an Ar glovebox (VAC Omni-Lab) with less than 0.5 ppm of oxygen for long-term storage.

Graphene-Ethyl Cellulose Production: Graphene-ethyl cellulose powder was produced using a previously established liquid-phase exfoliation method. Briefly, 100 g of 150 mesh flake graphite (Millipore Sigma) was mixed with 6 g of ethyl cellulose powder (4 cp, Millipore Sigma) and 1 L of 200-proof ethanol in a Silverson L 5M-A shear mixer at 10,230 RPM for 2 h. The dispersion was retrieved and centrifuged for 20 min at 7,500 RPM in a Beckman Coulter J26 XPI centrifuge to remove unexfoliated graphite, which was discarded. The supernatant from this step was then flocculated with a 0.04 g/mL solution of NaCl in water until the final dispersion reached a 1.74:1 ratio of graphene dispersion: sodium chloride solution. After a final centrifugation step at 7,500 RPM for 7 min, the GrEC powder was harvested, rinsed with deionized water, vacuum filtered, and dried under infrared light overnight. The powder was analyzed using thermogravimetric analysis, which revealed that the GrEC powder was approximately 50 wt % graphene.

Humidity Exposure: A chamber was used to expose LNO powders to humid CO₂ (99.9% purity). Specifically, incoming CO₂ (99.9% purity) was humidified prior to reaching the chamber by flowing through an Erlenmeyer flask that was filled halfway with deionized water, placed on a hotplate set at 100 °C, and sealed with a rubber stopper. Two plastic tubes were inserted into the two holes in the rubber stopper to supply incoming dry CO₂ and carry outgoing humidified CO₂, allowing the flask to function as a bubbler. A small hygrometer was left inside the chamber to measure the internal relative humidity, which was approximately 60% RH during gas flow. After humidity exposure, the powder was retrieved and dried in an 80 °C vacuum oven (ThermoFisher Lindberg Blue M) overnight to desorb additional moisture prior to subsequent analysis and electrode fabrication. The powder was then moved into an Ar glovebox (VAC Omni-Lab) for long-term storage.

Electrode Fabrication: Control electrodes were fabricated by mixing a 90:5:5 mass ratio of LNO, Super P conductive carbon black (MTI Corporation), and polyvinylidene fluoride (PVDF, MTI Corporation). To improve slurry homogeneity, the PVDF was dissolved in N-Methyl 2-pyrrolidone (NMP, anhydrous, Millipore Sigma) at 60 °C overnight to form a 6 wt % solution. The PVDF solution and carbon black were first mixed with additional NMP such that the total solids percentage in the final slurry was approximately 45% by weight. Mixing was performed in a centrifugal mixer (Thinky USA) at 800 RPM for 3 min, 1200 RPM for 3 min, 1600 RPM for 3 min, 2000 RPM for 3 min, and 2000 RPM for 3 min. In between each mixing step, the slurry was allowed to rest for 1 min without agitation. After a homogeneous slurry of carbon black, PVDF, and NMP was obtained, LNO was added and mixed again using the same protocol. The slurry was then cast onto carbon-coated aluminum foil (MTI Corporation), dried in a convection oven set at 120 °C for 15 min (BINDER GmbH), and followed by a final drying step under dynamic vacuum at 80 °C overnight (ThermoFisher Lindberg Blue M). The resulting active material loading was approximately 5 mg_{LNO} cm⁻². Electrode discs were punched out and calendered to a final electrode porosity of approximately 40% using an electric cold roller press (MTI Corporation).

To coat LNO particles, GrEC powder was first dispersed in a 5.33:1 vol/vol mixture of ethanol and NMP (anhydrous, Millipore Sigma). The ratio of ethanol to graphene in the mixture was approximately 5 mg mL⁻¹. To impart mechanical stability to the coating, multiwalled carbon nanotubes (MWCNTs, Millipore Sigma) were also added such that the mass ratio of graphene to MWCNTs was approximately 8:1. These components were homogeneously dispersed using a Fisher Scientific Sonic Dismembrator Model 500 equipped with a ¼ inch tip for 1 h at a power output of 40 W. Next, the dispersion was placed on a hotplate set at 90 °C to evaporate the ethanol. LNO powder was added to the dispersion at a 97.5:2 mass ratio of LNO to graphene and homogeneously incorporated into the dispersion using a centrifugal mixer (Thinky USA). The mixing protocol used was 800 RPM for 3 min, 1200 RPM for 3 min, 1600 RPM for 3 min, 2000 RPM for 3 min, and 2000 RPM for 3 min, with a 1 min rest period in between each mixing step. The dispersion was used for electrode preparation by casting onto aluminum foil, drying at 120 °C for 15 min in a convection oven (BINDER GmbH) and a final step in an 80 °C vacuum oven (ThermoFisher Lindberg Blue M) for overnight drying. LNO-GrEC electrodes with active material loadings of approximately 5 mg cm⁻² were punched out and calendered identically to the control electrodes. EC pyrolysis was accomplished by heating samples under flowing O₂ in a tube furnace (ThermoFisher Lindberg Blue M) to 300 °C for 1 h at a 5 °C min⁻¹ ramp rate.

Coin cells (2032-type) were assembled in an Ar glovebox (VAC Omni-Lab). Cells were assembled with Celgard 2325 as the separator and lithium metal (China Energy Lithium, Co.) as the counter electrode. In each coin cell, 100 μL of 1 M LiPF₆ in ethylene carbonate/ethyl methyl carbonate (EC/EMC, 50/50 v/v, Millipore Sigma) was used as the electrolyte.

Electrochemical Characterization: Galvanostatic cycling was performed between 2.8 V and 4.6 V vs. Li/Li⁺ with an Arbin LBT-20084 64-channel battery cycler. The cells were activated with 5 cycles at 0.1 C using a constant-current constant-voltage protocol on discharge, where the voltage was held constant at the end of the discharge step until a cutoff value of C/20. Here, 1 C is defined as the current required to fully discharge LNO in 1 h. Electrochemical impedance spectroscopy (EIS) measurements were performed on fully discharged cells using a Bio-Logic VSP potentiostat between 1 MHz and 10 mHz. Equivalent circuit modeling was performed using the EC-Lab software (Biologic).

Scanning Electron Microscopy: A Hitachi SU8030 SEM was used for scanning electron microscopy. Powder was deposited onto double sided carbon tape adhered to an SEM stub. Prior to imaging, samples were also coated with 7 nm of Os using an Osmium Coater (SPI supplies). Imaging was performed at an accelerating voltage of 2 kV or 10 kV and a current of 10 mA.

X-Ray Photoelectron Spectroscopy: X-Ray photoelectron spectroscopy analysis was performed using a Thermo Scientific ESCALAB 250 Xi+ (Al Kα radiation, about 1486.6 eV) at a base pressure of about 2×10⁻⁸ Torr and an analysis spot size of 900 μm. During the analysis, samples were charge compensated with a flood gun. Depth profiling was performed with an Ar⁺ gun at 2 keV, corresponding to an approximate etching rate of 0.11 nm sec⁻¹. To prepare samples for analysis, a spatula was used to press powder onto double-sided copper adhesive tape on the sample holder, which left an optically dense layer of LNO. The amount of ambient exposure time during this step was less than 30 s. Peak fitting was performed using the Thermo Scientific Avantage software, with charge calibration set to adventitious carbon at about 284.8 eV.

Fourier Transform Infrared Spectroscopy: Fourier Transform Infrared Spectroscopy was performed in diffuse reflectance mode using a Nicolet iS50 spectrometer (Thermo Fisher) equipped with a DRIFTS module. To prepare samples for DRIFTS-FTIR, KBr powder was mixed with LNO at a ratio of 99:1 using a mortar and pestle inside an Ar glovebox. Spectra were acquired with an average of 64 scans at a resolution of 4 cm⁻¹. Since the scans were conducted in ambient conditions with CO₂ present, the spectra of the LNO powders were normalized using the intensities of the CO₂ doublet (located at 2330 cm⁻¹ and 2360 cm⁻¹) to allow for direct comparison between samples.

Raman Spectroscopy: Raman spectroscopy was conducted using a HORIBA LabRAM HR Evolution Confocal Raman Microscope equipped with a 532 nm laser. 60 spectra were acquired and averaged using a 600 g/mm grating for 5 s.

Thermogravimetric Analysis: Thermogravimetric analysis was performed using a Mettler Toledo TGA/DSC 3+ under flowing dry air. Prior to TGA, all powders were dried at 80 °C under dynamic vacuum to desorb moisture and then loaded into alumina crucibles for data acquisition.

### Results and Discussion

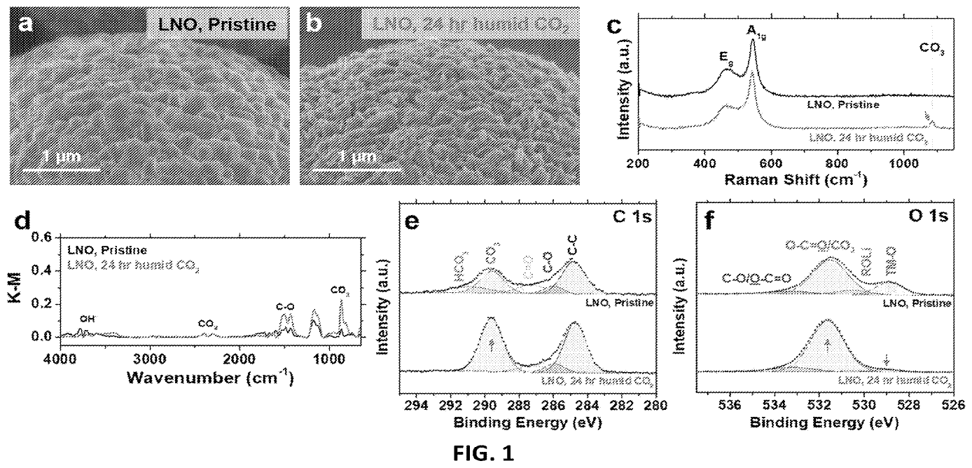

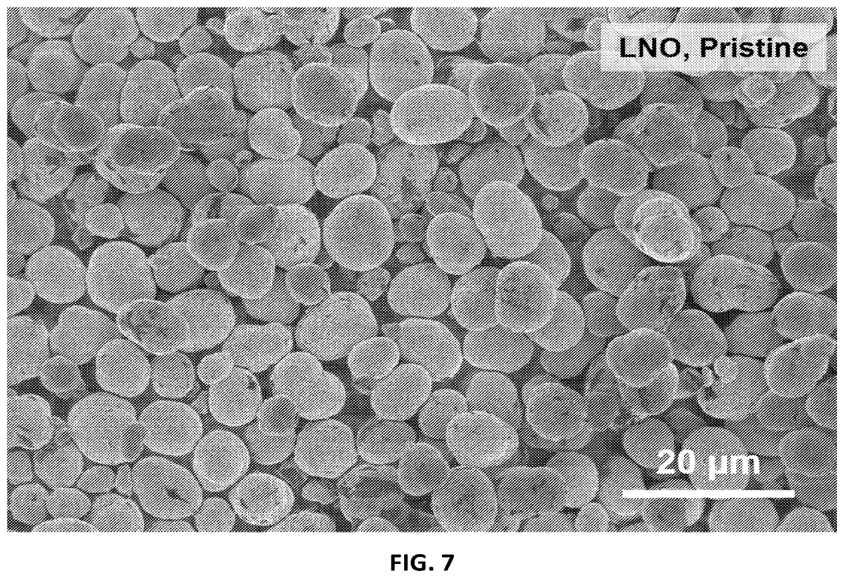

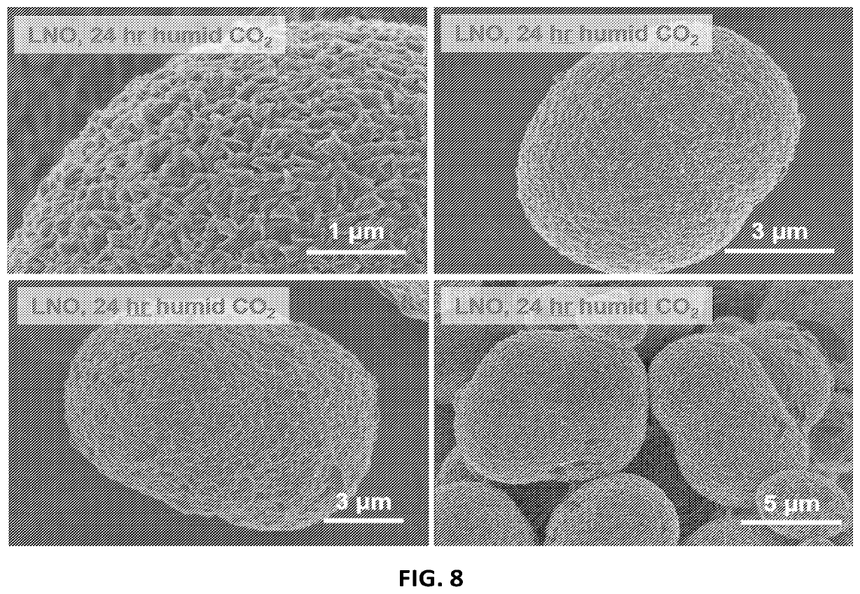

LNO powders were synthesized via a hydroxide co-precipitation and calcination method, yielding secondary particles of LNO that were approximately 10 μm in diameter (FIG. 7). Scanning electron microscopy (SEM) showed that these secondary particles were composed of individual LNO grains, which each exhibited a smooth surface morphology (panel a of FIG. 1) immediately after particle synthesis. After 24 hours of exposure to humidified CO₂, the LNO surface became rough, with jagged features that rendered individual grains indistinguishable from one another (panel b of FIG. 1 and FIG. 8). This transformation was indicative of degradation induced by the humid CO₂ exposure and was consistent with surface changes observed in other Ni-rich cathode systems. To further investigate the chemical changes associated with this apparent surface morphological transformation, the degraded samples were interrogated with Raman spectroscopy, diffuse reflectance infrared Fourier transform spectroscopy (DRIFTS-FTIR), and X-ray photoelectron spectroscopy (XPS).

Raman spectroscopy of pristine LNO showed peaks that were assigned to the Ni—O A_{1g} (540 cm⁻¹) and the Eg (460 cm⁻¹) vibrational modes (panel c of FIG. 1, top), with no other peaks clearly present. Surface-sensitive DRIFTS-FTIR of pristine LNO revealed spectral intensities at wavenumbers consistent with C—O stretching (1500 cm⁻¹ and 1435 cm⁻¹) and CO₃ bending (865 cm⁻¹) (panel d of FIG. 1), which suggest that organic species and lithium carbonate impurities were weakly present. To further interrogate these surface species, XPS was used to carefully identify the chemical nature of the pristine LNO surface. The XPS C 1s spectrum was fit with component peaks assigned to adventitious C—C bonding at 284.8 eV, C—O bonding at 286 eV, and C—O bonding at 287.3 eV (panel e of FIG. 1, top). At higher binding energies, spectral intensities were observed and fit to lithium impurities CO₃ and HCO₃ at 289.6 eV and 290.9 eV, respectively. Meanwhile, the O 1s spectrum was fit with component peaks assigned to Ni—O bonding at 528.9 eV, ROLi bonding at 530.5 eV, O—C═O/CO₃ bonding at 531.5 eV, and C—O/O—C═O bonding at 533.2 eV (panel f of FIG. 1, top). Taken together, these results suggested that the pristine LNO was relatively clean, containing surface organic species and carbonate impurities that are generally expected for Ni-rich layered oxides following synthesis.

Exposure of the LNO to humid CO₂ induced significant spectroscopic changes, which allowed chemical identification of the morphological changes observed in SEM. First, Raman spectroscopy (panel c of FIG. 1, bottom) showed the emergence of a peak at 1080 cm⁻¹ that was spectrally consistent with prior reports of carbonate vibrations in Ni-rich cathodes. Second, DRIFTS-FTIR (panel d of FIG. 1) revealed that spectral intensities assigned to C—O stretching (1500 cm⁻¹ and 1430 cm⁻¹) and out-of-plane CO₃ bending (865 cm⁻¹) increased following exposure to humid CO₂, which is consistent with an increase in carbonate species on the LNO surface. Finally, the XPS C 1s spectrum showed an increase in the carbonate spectral intensities after exposure to humid CO₂ (panel e of FIG. 1, bottom), while the XPS O 1s spectrum revealed that the carbonate spectral intensities increased simultaneously with decreased transition metal-oxygen (TM-O) bonding intensities (panel f of FIG. 1, bottom). Since these TM-O spectral intensities originate from Ni—O bonding in LNO, these results suggest that an additional carbonate-rich layer is formed on the LNO surface during exposure to humid CO₂.

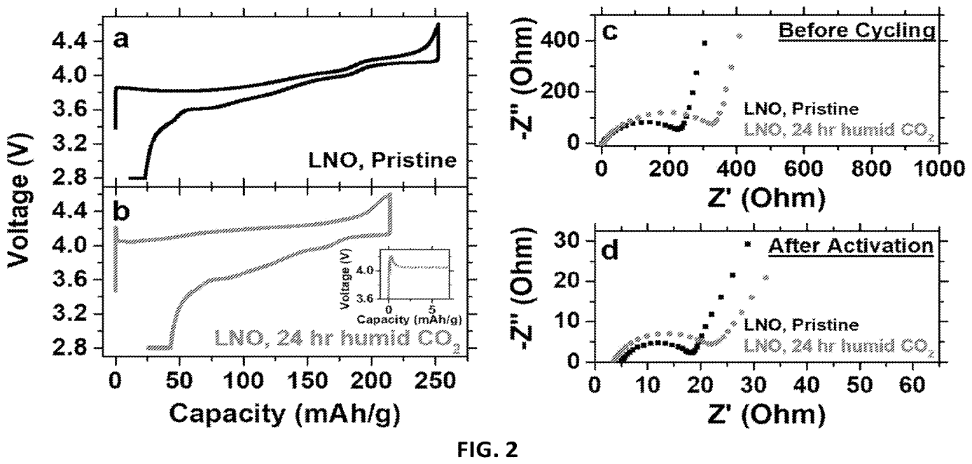

Humid CO₂ exposure severely degraded the electrochemical performance of uncoated LNO, which was evident in the initial activation cycle. As a baseline, pristine LNO achieved an initial charge capacity of 252 mAh g⁻¹ and a discharge capacity of 240 mAh g⁻¹, with low polarization during the charge-discharge process (panel a of FIG. 2). In contrast, LNO exposed to humid CO₂ exhibited severe charge-discharge polarization, resulting in a low charge capacity of 214 mAh g⁻¹ and a corresponding discharge capacity of 189 mAh g⁻¹ (panel b of FIG. 2), which were about 15% and about 21% lower than the pristine LNO charge and discharge capacities, respectively. The shape of the initial charge process provided an additional signature of the carbonate impurities that were generated during humid CO₂ exposure. The initial delithiation voltage for LNO is known to occur at approximately 3.7 V vs. Li/Li⁺, which was observed for pristine LNO. However, the voltage shoulder for LNO exposed to humid CO₂ was measured at approximately 4.0 V vs. Li/Li⁺, corresponding to a about 300 m V overpotential. Moreover, above this voltage shoulder, a peak was evident (panel b of FIG. 2, inset), which has been observed previously and is characteristic of the electrochemical removal of impurity species on the LNO surface. This feature was not present in the voltage profile for pristine LNO.

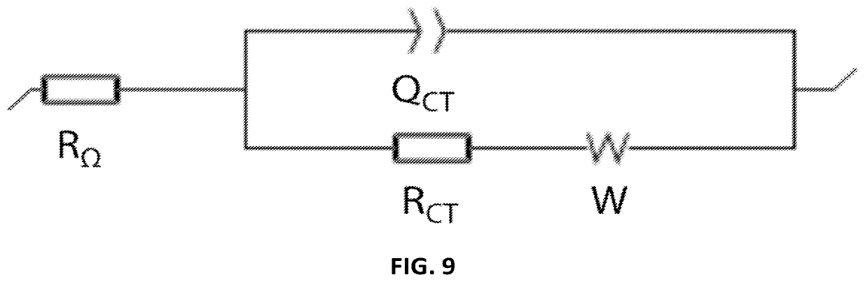

The increase in electrode polarization was also assessed via electrochemical impedance spectroscopy (EIS) and equivalent circuit modeling using a Randles circuit (panels c-d of FIG. 2 and FIG. 9). Before activation, the charge transfer resistance was higher for the cell fabricated with LNO exposed to humid CO₂ (313.2Ω) compared to pristine LNO (213.8Ω). These results indicated that the surface layer of impurities that formed during humid CO₂ exposure was detrimental to the initial electrochemical behavior and further corroborated the observed polarization increase in the voltage-capacity plots of the initial cycle. After activation, the cell fabricated with LNO exposed to humid CO₂ had a higher measured charge transfer resistance (17.2Ω) compared to pristine LNO (12.1Ω), suggesting that lithium impurities negatively impact cell behavior beyond the initial activation protocol.

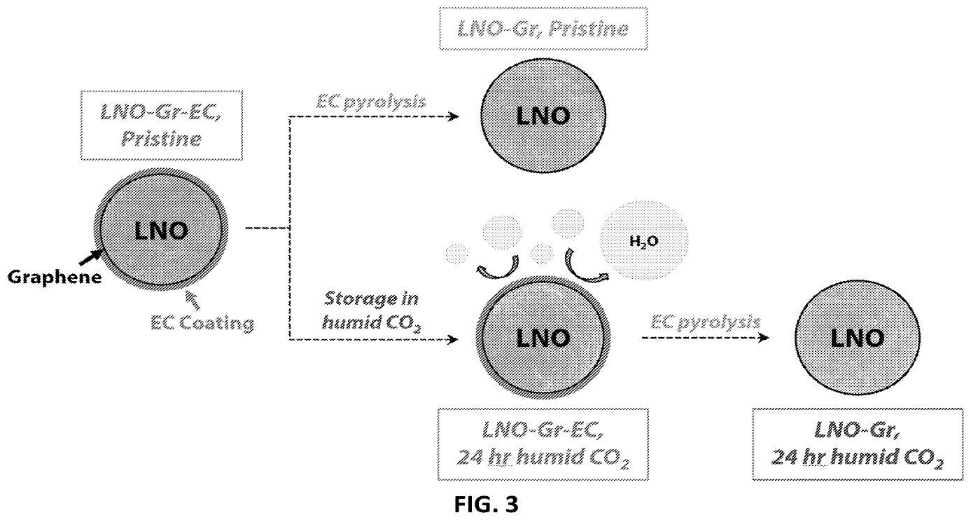

To address the issue of ambient-induced degradation, LNO particles were encapsulated with a protective barrier layer to preserve the pristine surface state. Since the ambient degradation of Ni-rich layered oxides requires the presence of both moisture and CO₂, limiting the availability of moisture via an external, hydrophobic barrier layer is a promising strategy for preventing the formation of surface carbonates and hydroxides. Towards this end, LNO particles were encapsulated with a GrEC coating (FIG. 3). Graphene and EC were selected due to their inherent hydrophobic character and combined ability to form a conformal coating on particles. In particular, the EC filled in gaps between the graphene nanoflakes, ensuring that the LNO particles were uniformly encapsulated and protected from ambient degradation. Since EC is electrically insulating, it is removed via a low-temperature pyrolysis step prior to electrochemical testing, which decomposes the EC into low molecular weight aromatic carbon with high sp² character. These carbonaceous residues bridge the graphene flakes, thus creating a percolating electronically conductive network throughout the electrode that aided charge transport as has been previously demonstrated for other Ni-rich cathodes such as NMC532, NCA and LNO.

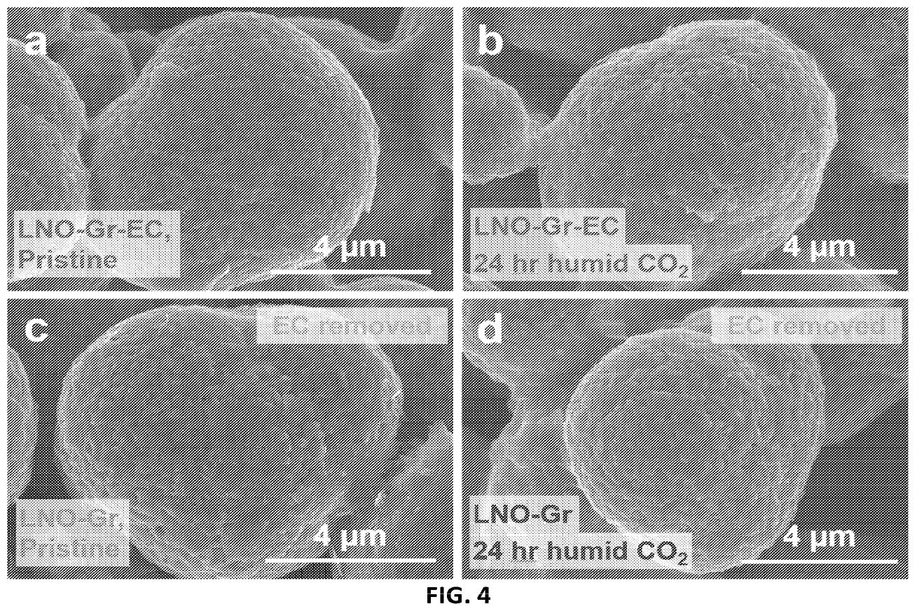

Experimentally, LNO particles were coated by homogeneously combining a GrEC dispersion in N-methyl-2-pyrrolidone (NMP) with LNO powder using a centrifugal mixer. A subsequent solvent removal step yielded LNO-Gr-EC, where the graphene and EC formed a uniform coating on the LNO surface (panel a of FIG. 4). The LNO-Gr-EC was then subjected to 24 hours of exposure to humid CO₂ and examined for changes to the particle surface morphology. SEM showed that the GrEC coating successfully preserved the quality of the LNO surface during the humid CO₂ exposure, as evidenced by the lack of changes to the secondary particle shape (panel b of FIG. 4). Individual primary particles of LNO were visible below the thin coating layer and exhibited no discernable changes in surface morphology, in contrast to the uncoated LNO exposed to humid CO₂ (panel b of FIG. 1). Since any exposed LNO surfaces would rapidly react and form impurity species under these humid CO₂ exposure conditions, the SEM images suggested that the GrEC coating was conformal and free of pinhole defects.

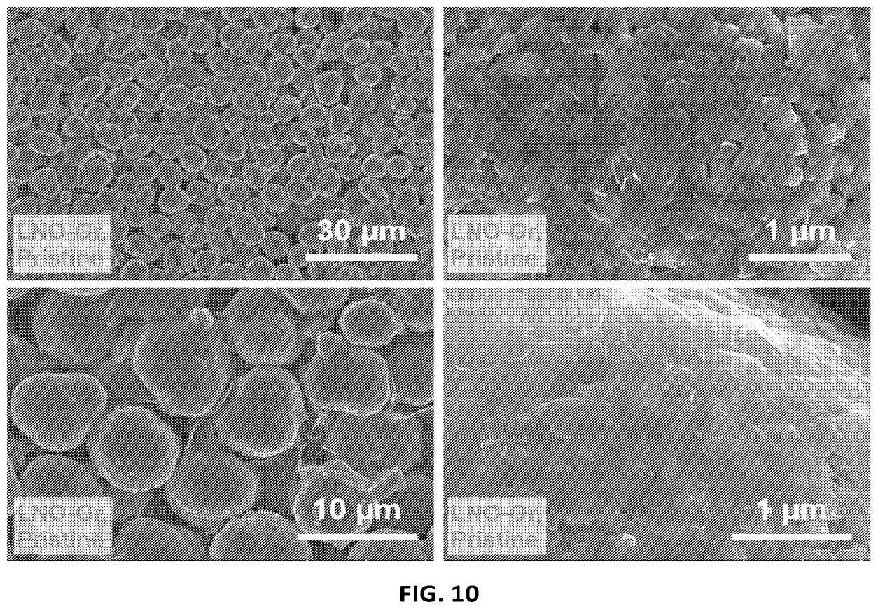

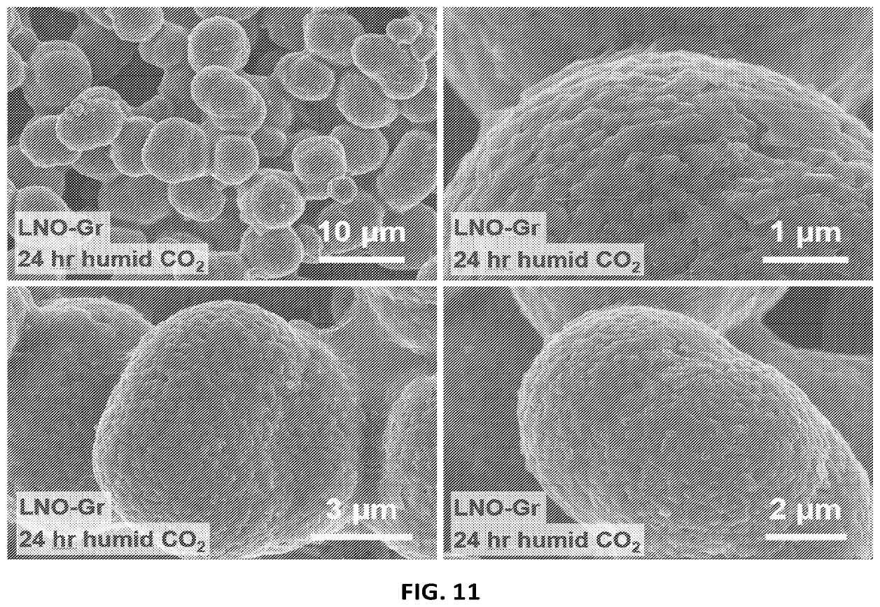

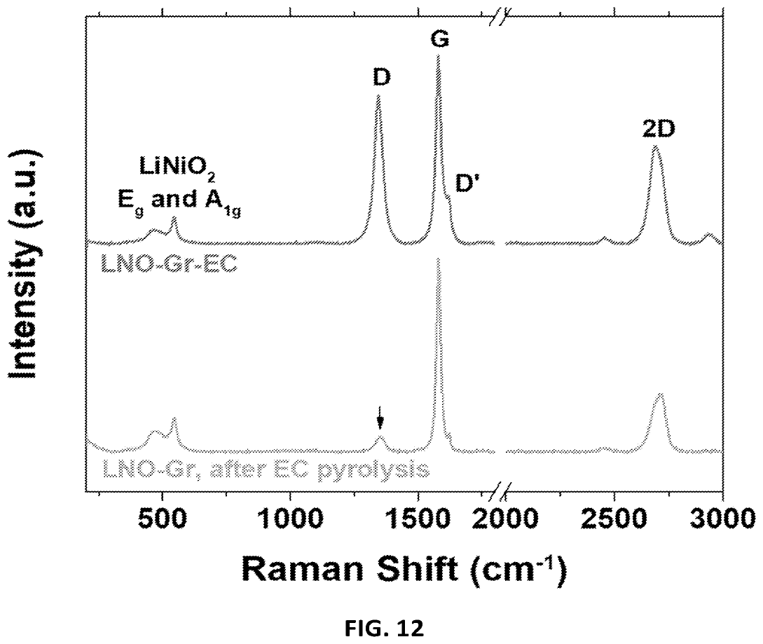

In preparation for electrochemical cycling and spectroscopic analysis, the EC layer was removed from the system by heating the LNO-Gr-EC in flowing O₂ to 300 °C, yielding LNO-Gr. The EC pyrolysis was conducted on as-coated samples (LNO-Gr, panel c of FIG. 4 and FIG. 10), as well as samples that were coated and then exposed to humid CO₂ for 24 hours (LNO-Gr, 24 hr humid CO₂, panel c of FIG. 4 and FIG. 11). Raman spectroscopy indicated that the graphene D/G ratio decreased after this heating step, confirming the decomposition of EC (FIG. 12). The coating uniformity and quality were invariant even after thermal pyrolysis of EC, demonstrating that this scheme was robust and yielded active materials that were compatible with subsequent electrode fabrication procedures.

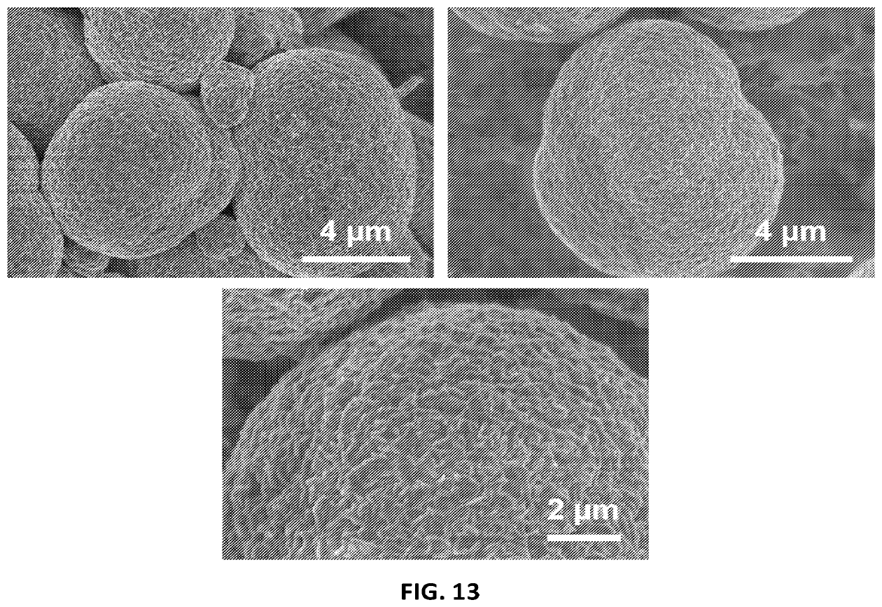

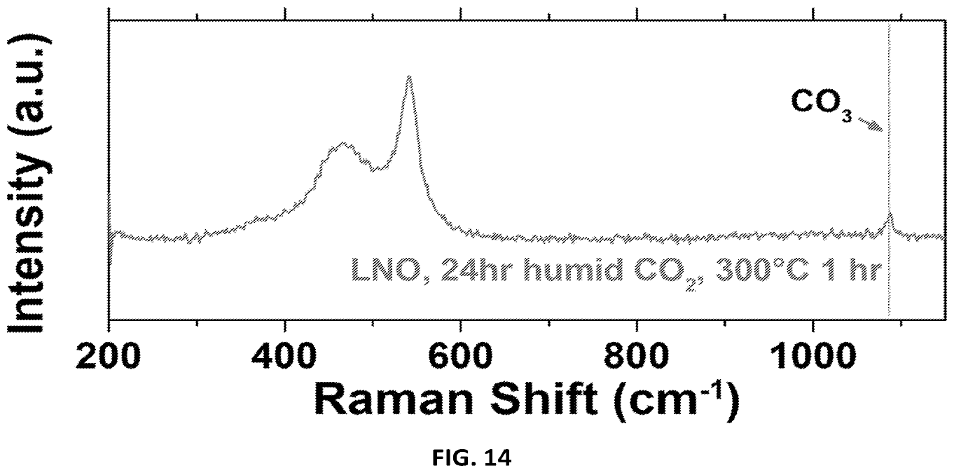

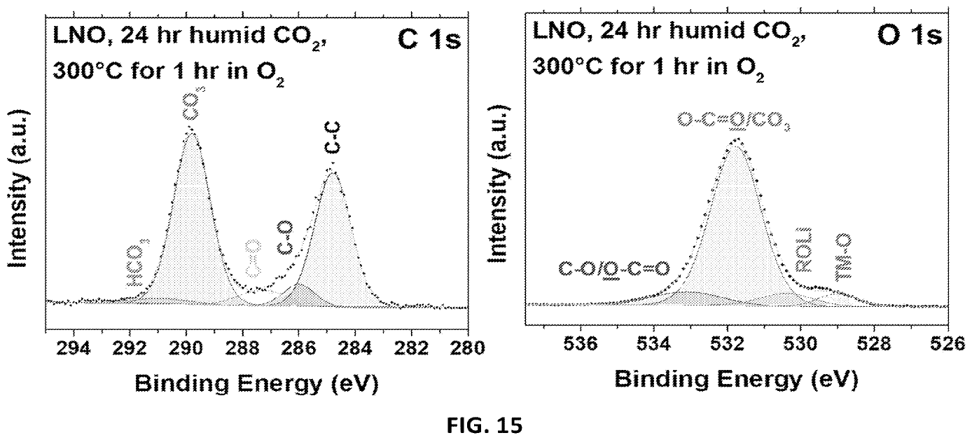

Since the pyrolysis temperature of EC (300 °C) is lower than the decomposition temperatures of LiHCO₃ (350 °C), LiOH (400 °C), or Li₂CO₃ (725 °C), surface impurities generated during exposure to humid CO₂ should be preserved following the EC removal step and thus detectable via subsequent spectroscopic analysis. To confirm whether the EC pyrolysis conditions were sufficient to induce changes in the surface morphology or chemistry, uncoated LNO that was exposed to humid CO₂ was subjected to the same thermal treatment. Subsequent SEM, Raman, and XPS analysis of this powder showed that the rough surface morphology and carbonate spectral intensities persisted through the heating procedure (FIGS. 13-15). These results suggest that if lithium impurities formed on the LNO-Gr-EC during storage, the EC removal step would not remove them from the LNO surface.

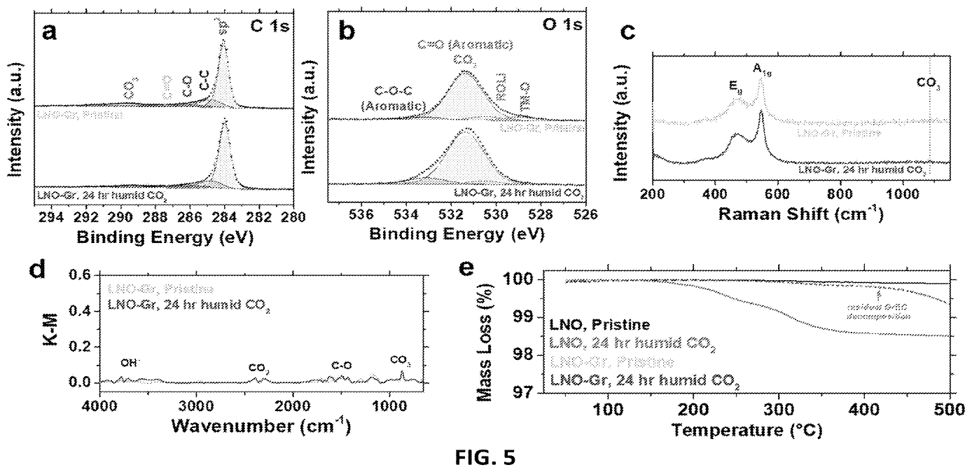

Following the removal of the EC coating, spectroscopic and gravimetric methods that directly interrogated the LNO-Gr surface revealed that the GrEC coating indeed mitigated the formation of surface carbonates and hydroxides upon the exposure to humid CO₂. The XPS C 1s spectra were fit with the same component peaks as the uncoated LNO, with the addition of sp² bonding at 284.0 eV due to the presence of graphene. No significant changes were observed in the XPS C 1s spectra between the pristine and humid-CO₂ LNO-Gr samples (panel a of FIG. 5). In the O 1s spectra, component peaks corresponding to aromatic C═O/CO₃ and C—O—C were assigned at 533.2 eV and 531.5 eV to account for the carbonaceous residue produced by EC pyrolysis (panel b of FIG. 5), but again no significant changes were observed between the pristine and humid-CO₂ LNO-Gr samples. Similarly, the Raman spectra of the LNO-Gr samples before and after humid CO₂ exposure showed no appreciable differences, especially near the spectral vicinity of carbonate vibrational modes (1080 cm⁻¹, panel c of FIG. 5). This trend was also observed for the DRIFTS-FTIR spectra, which showed no substantial differences in the intensities corresponding to C—O stretching (1500 cm⁻¹ and 1435 cm⁻¹) and CO₃ bending (865 cm⁻¹, panel d of FIG. 5). Finally, since impurity species should desorb or decompose at high temperatures, thermogravimetric analysis (TGA) was performed to quantify the amount of impurity species present on the LNO (panel e of FIG. 5). Upon heating to 500 °C, the pristine LNO showed minimal mass loss (less than 0.1 wt %), suggesting that the LNO was relatively impurity-free. In contrast, the uncoated LNO exposed to 24 hours of humid CO₂ lost 1.5% of its mass upon heating to 500 °C, which was attributed to the decomposition of carbonate species near 350 °C

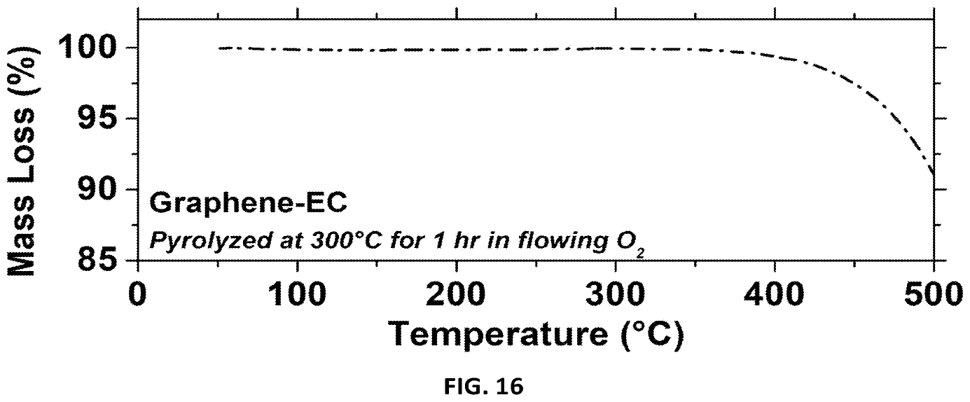

Compared to the uncoated LNO, the mass loss behavior for the GrEC-coated LNO before and after exposure to humid CO₂ was nearly identical (0.7 wt % loss at 500 °C), which suggested that the impurity levels on both samples were comparably low. Notably, both LNO-Gr samples exhibited a mass decrease beginning at approximately 300 °C. Since other analytical techniques suggested that the LNO-Gr sample was largely free of impurities, this mass loss was attributed to the pyrolysis of the carbonaceous residue that remained after the initial EC removal. To test this hypothesis, TGA was performed on GrEC powder that was pre-pyrolyzed under identical conditions as the LNO-Gr samples (FIG. 16). The GrEC powder similarly showed mass loss below 500 °C, confirming that the mass loss observed for the LNO-Gr samples was due to the pyrolysis of residual carbon.

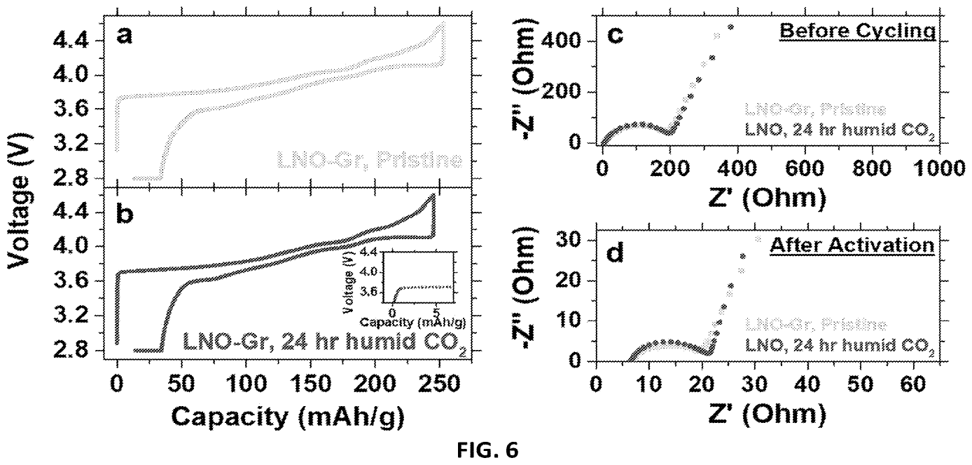

Finally, the LNO-Gr electrodes were galvanostatically cycled to search for electrochemical signatures of impurity species. During the activation cycle, the pristine LNO-Gr sample exhibited no evidence of compromised electrochemical behavior, achieving a charge capacity of 253 mAh g⁻¹ and a discharge capacity of 240 mAh g⁻¹ (panel a of FIG. 6). Similarly, the LNO-Gr sample after exposure to humid CO₂ achieved a charge capacity of 245 mAh g⁻¹ and a discharge capacity of 230 mAh g⁻¹ without a discernable voltage peak at the shoulder near 3.7 V vs. Li/Li⁺ (panel b of FIG. 6). The charge transfer resistances of the pristine LNO-Gr sample and the LNO-Gr sample after exposure to humid CO₂ were similar before cycling (176.9Ω vs. 191Ω, respectively; panel c of FIG. 6) and after activation (12.3Ω vs. 13.2Ω, respectively; panel d of FIG. 6). Altogether, the galvanostatic cycling and EIS results showed that the GrEC coating protected the LNO from degradation during exposure to humid CO₂ and had no deleterious effects on subsequent electrochemical behavior.

Overall, this work builds upon prior research that investigated the value imparted by GrEC coatings on a wide range of lithium-ion battery electrode chemistries in the context of cycling stability and electronic conductivity. By using the same technology to address the ambient sensitivity of LNO, which has extremely strict storage requirements among the family of Ni-rich layered oxides, this work demonstrates a secondary material platform that can be broadly applied not only to lithium-ion battery cathode materials but also other ambient-reactive materials that can benefit from the additional electronic conductivity imparted by pyrolyzed GrEC coatings.

### CONCLUSION

In sum, this invention addresses the ambient degradation of LNO by coating particles with a uniform, hydrophobic coating composed of graphene and ethyl cellulose. Compared to a control sample of bare LNO powder, which formed significant surface lithium impurities after 24 hours of exposure to humid CO₂, the coated LNO-Gr-EC was highly resistant to degradation. X-ray photoelectron, Raman, and DRIFTS-FTIR spectroscopies showed no spectral evidence of carbonate formation on LNO-Gr-EC after exposure to humid CO₂, corroborating the lack of surface morphological changes in SEM and mass changes in TGA. Moreover, the presence of lithium impurities is known to introduce greater electrode polarization, higher impedance, and a voltage peak near the delithiation shoulder in the activation cycle, indicating that the lithium impurities severely compromise electrochemical performance. These characteristics were clearly present for uncoated LNO following exposure to humid CO₂ but were absent for the coated LNO-Gr-EC electrode exposed to the same conditions. Overall, this study establishes a scalable strategy for improving the ambient stability of Ni-rich cathode materials. By demonstrating this scheme for the Ni-rich limit of the layered lithium transition metal oxide family (i.e., LNO), this work can also be applied to related Ni-rich chemistries such as NMC and NCA that are widely used in electric vehicles and related energy storage technologies.

The foregoing description of the exemplary embodiments of the invention has been presented only for the purposes of illustration and description, and is not intended to be exhaustive or to limit the invention to the precise forms disclosed. Many modifications and variations are possible in light of the above teaching.

The embodiments were chosen and described to explain the principles of the invention and their practical application to enable others skilled in the art to utilize the invention and various embodiments and with various modifications suited to the particular use contemplated.

Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Li, W.; Erickson, E. M.; Manthiram, A. High-Nickel Layered Oxide Cathodes for Lithium-Based Automotive Batteries. Nature Energy 2020, 5 (1), 26-34. DOI: 10.1038/s41560-019-0513-0.
[2] Li, W.; Asl, H. Y.; Xie, Q.; Manthiram, A. Collapse of LiNi_{1-x-y}CoₓMn_{y}O₂ Lattice at Deep Charge Irrespective of Nickel Content in Lithium-Ion Batteries. Journal of the American Chemical Society 2019, 141 (13), 5097-5101. DOI: 10.1021/jacs.8b13798.
[3] Li, W.; Liu, X.; Xie, Q.; You, Y.; Chi, M.; Manthiram, A. Long-Term Cyclability of NCM-811 at High Voltages in Lithium-Ion Batteries: an In-Depth Diagnostic Study. Chemistry of Materials 2020, 32 (18), 7796-7804. DOI: 10.1021/acs.chemmater.0c02398.
[4] Jung, R.; Morasch, R.; Karayaylali, P.; Phillips, K.; Maglia, F.; Stinner, C.; Shao-Horn, Y.; Gasteiger, H. A. Effect of Ambient Storage on the Degradation of Ni-Rich Positive Electrode Materials (NMC811) for Li-Ion Batteries. Journal of The Electrochemical Society 2018, 165 (2), A132-A141. DOI: 10.1149/2.0401802jes.
[5] Liu, H. S.; Zhang, Z. R.; Gong, Z. L.; Yang, Y. Origin of Deterioration for LiNiO₂ Cathode Material during Storage in Air. Electrochemical and Solid-State Letters 2004, 7 (7), A190. DOI: 10.1149/1.1738471.
[6] Shizuka, K., Kiyohara, C.; Shima, K.; Takeda, Y. Effect of CO₂ on Layered Li_{1+z}Ni_{1-x-y}CoₓM_{y}O₂ (M=Al, Mn) Cathode Materials for Lithium Ion Batteries. Journal of Power Sources 2007, 166 (1), 233-238. DOI: 10.1016/j.jpowsour.2007.01.013.
[7] Faenza, N. V.; Bruce, L., Lebens-Higgins, Z. W.; Plitz, I.; Pereira, N.; Piper, L. F. J.; Amatucci, G. G. Growth of Ambient Induced Surface Impurity Species on Layered Positive Electrode Materials and Impact on Electrochemical Performance. Journal of The Electrochemical Society 2017, 164 (14), A3727-A3741. DOI: 10.1149/2.0921714jes.
[8] Liu, H.; Yang, Y.; Zhang, J. Investigation and Improvement on the Storage Property of LiNi_{0.8}Co_{0.2}O₂ as a Cathode Material for Lithium-Ion Batteries. Journal of Power Sources 2006, 162 (1), 644-650. DOI: 10.1016/j.jpowsour.2006.07.028.
[9] Toma, T.; Maezono, R.; Hongo, K. Electrochemical Properties and Crystal Structure of Li⁺/H⁺ Cation-Exchanged LiNiO₂. ACS Applied Energy Materials 2020, 3 (4), 4078-4087. DOI: 10.1021/acsaem.0c00602.
[10] Hartmann, L.; Pritzl, D.; Beyer, H.; Gasteiger, H. A. Evidence for Li⁺/H⁺ Exchange during Ambient Storage of Ni-Rich Cathode Active Materials. Journal of The Electrochemical Society 2021, 168 (7), 070507. DOI: 10.1149/1945-7111/ac0d3a.
[11] Pritzl, D.; Teufl, T.; Freiberg, A. T. S.; Strehle, B., Sicklinger, J.; Sommer, H.; Hartmann, P.; Gasteiger, H. A. Washing of Nickel-Rich Cathode Materials for Lithium-Ion Batteries: Towards a Mechanistic Understanding. Journal of The Electrochemical Society 2019, 166 (16), A4056-A4066. DOI: 10.1149/2.1351915jes.
[12] You, Y.; Celio, H.; Li, J.; Dolocan, A.; Manthiram, A. Modified High-Nickel Cathodes with Stable Surface Chemistry Against Ambient Air for Lithium-Ion Batteries. Angewandte Chemie International Edition 2018, 57 (22), 6480-6485. DOI: 10.1002/anie.201801533.
[13] Visbal, H.; Fujiki, S.; Aihara, Y.; Watanabe, T.; Park, Y.; Doo, S. The Influence of the Carbonate Species on LiNi_{0.8}Co_{0.15}Al_{0.05}O₂ Surfaces for All-Solid-State Lithium Ion Battery Performance. Journal of Power Sources 2014, 269, 396-402. DOI: 10.1016/j.jpowsour.2014.07.021.
[14] Chen, Z.; Wang, J.; Huang, J.; Fu, T.; Sun, G.; Lai, S.; Zhou, R.; Li, K.; Zhao, J. The High-Temperature and High-Humidity Storage Behaviors and Electrochemical Degradation Mechanism of LiNi_{0.6}Co_{0.2}Mn_{0.2}O₂ Cathode Material for Lithium Ion Batteries. Journal of Power Sources 2017, 363, 168-176. DOI: 10.1016/j.jpowsour.2017.07.087.
[15] Renfrew, S. E.; Kaufman, L. A.; McCloskey, B. D. Altering Surface Contaminants and Defects Influences the First-Cycle Outgassing and Irreversible Transformations of LiNi_{0.6}Mn_{0.2}Co_{0.2}O₂. ACS Applied Materials & Interfaces 2019, 11 (38), 34913-34921. DOI: 10.1021/acsami.9b09992.
[16] Renfrew, S. E.; McCloskey, B. D. Quantification of Surface Oxygen Depletion and Solid Carbonate Evolution on the First Cycle of LiNi_{0.6}Mn_{0.2}Co_{0.2}O₂ Electrodes. ACS Applied Energy Materials 2019, 2 (5), 3762-3772. DOI: 10.1021/acsaem.9b00459.
[17] Renfrew, S. E.; McCloskey, B. D. Residual Lithium Carbonate Predominantly Accounts for First Cycle CO₂ and CO Outgassing of Li-Stoichiometric and Li-Rich Layered Transition-Metal Oxides. Journal of the American Chemical Society 2017, 139 (49), 17853-17860. DOI: 10.1021/jacs.7b08461.
[18] Sicklinger, J.; Metzger, M.; Beyer, H.; Pritzl, D.; Gasteiger, H. A. Ambient Storage Derived Surface Contamination of NCM811 and NCM111: Performance Implications and Mitigation Strategies. Journal of The Electrochemical Society 2019, 166 (12), A2322-A2335. DOI: 10.1149/2.0011912jes.
[19] Zhai, Y.; Yang, W.; Ning, D.; Yang, J.; Sun, L.; Schuck, G.; Schumacher, G.; Liu, X. Improving the Cycling and Air-Storage Stability of LiNi_{0.8}Co_{0.1}Mn_{0.1}O₂ through Integrated Surface/Interface/Doping Engineering. Journal of Materials Chemistry A 2020, 8 (10), 5234-5245. DOI: 10.1039/C9TA13014D.
[20] Seong, W. M.; Kim, Y.; Manthiram, A. Impact of Residual Lithium on the Adoption of High-Nickel Layered Oxide Cathodes for Lithium-Ion Batteries. Chemistry of Materials 2020, 32 (22), 9479-9489. DOI: 10.1021/acs.chemmater.0c02808.
[21] Seong, W. M.; Cho, K.-H.; Park, J.-W.; Park, H.; Eum, D.; Lee, M. H.; Kim, I.-s. S.; Lim, J.; Kang, K. Controlling Residual Lithium in High-Nickel (>90%) Lithium Layered Oxides for Cathodes in Lithium-Ion Batteries. Angewandte Chemie International Edition 2020, 59 (42), 18662-18669. DOI: 10.1002/anie.202007436.
[22] Bi, Y.; Li, Q.; Yi, R., Xiao, J. To Pave the Way for Large-Scale Electrode Processing of Moisture-Sensitive Ni-Rich Cathodes. Journal of The Electrochemical Society 2022, 169 (2), 020521. DOI: 10.1149/1945-7111/ac4e5d.
[23] Ramakrishnan, S.; Park, B.; Wu, J.; Yang, W.; McCloskey, B. D. Extended Interfacial Stability through Simple Acid Rinsing in a Li-Rich Oxide Cathode Material. Journal of the American Chemical Society 2020, 142 (18), 8522-8531. DOI: 10.1021/jacs.0c02859.
[24] Kim, H.; Lee, K.; Kim, S.; Kim, Y. Fluorination of Free Lithium Residues on the Surface of Lithium Nickel Cobalt Aluminum Oxide Cathode Materials for Lithium Ion Batteries. Materials & Design 2016, 100, 175-179. DOI: 10.1016/j.matdes.2016.03.121.
[25] Liu, M.; Jiang, Y.; Qin, Y.; Feng, Z.; Wang, D.; Guo, B. Enhanced Electrochemical Performance of Ni-Rich Cathodes by Neutralizing Residual Lithium with Acid Compounds. ACS Applied Materials & Interfaces 2021, 13 (46), 55072-55079. DOI: 10.1021/acsami.1c16482.
[26] Zheng, X., Li, X.; Wang, Z., Guo, H.; Huang, Z.; Yan, G.; Wang, D. Investigation and Improvement on the Electrochemical Performance and Storage of LiNiO₂-Based Materials for Lithium Ion Battery. Electrochimica Acta 2016, 191, 832-840. DOI: 10.1016/j.electacta.2016.01.142.
[27] Lv, C.; Li, Z.; Ren, X.; Li, K.; Ma, J.; Duan, X. Revealing the Degradation Mechanism of Ni-Rich Cathode Materials After Ambient Storage and Related Regeneration Method. Journal of Materials Chemistry A 2021, 9 (7), 3995-4006. DOI: 10.1039/DOTA10378K.
[28] Lim, J.-M.; Luu, N. S.; Park, K.-Y.; Tan, M. T. Z.; Kim, S.; Downing, J. R.; He, K.; Dravid, V. P.; Hersam, M. C. Enhancing Nanostructured Nickel-Rich Lithium-Ion Battery Cathodes via Surface Stabilization. Journal of Vacuum Science & Technology A 2020, 38 (6), 063210. DOI: 10.1116/6.0000580.
[29] Xie, Q.; Manthiram, A. Long-Life, Ultrahigh-Nickel Cathodes with Excellent Air Storage Stability for High-Energy Density Lithium-Based Batteries. Chemistry of Materials 2020, 32 (17), 7413-7424. DOI: 10.1021/acs.chemmater.0c02374.
[30] Kim, Y.; Park, H.; Dolocan, A.; Warner, J. H.; Manthiram, A. Wet-CO₂ Pretreatment Process for Reducing Residual Lithium in High-Nickel Layered Oxides for Lithium-Ion Batteries. ACS Applied Materials & Interfaces 2021, 13 (23), 27096-27105. DOI: 10.1021/acsami.1c06277.
[31] Yuan, C.; Deng, Y.; Li, T.; Yang, F. Manufacturing Energy Analysis of Lithium Ion Battery Pack for Electric Vehicles. CIRP Annals 2017, 66 (1). DOI: 10.1016/j.cirp.2017.04.109.
[32] Doo, S. W.; Lee, S.; Kim, H.; Choi, J. H.; Lee, K. T. Hydrophobic Ni-Rich Layered Oxides as Cathode Materials for Lithium-Ion Batteries. ACS Applied Energy Materials 2019, 2 (9), 6246-6253. DOI: 10.1021/acsaem.9b00786.
[33] Gu, W.; Dong, Q.; Zheng, L.; Liu, Y.; Mao, Y.; Zhao, Y.; Duan, W.; Lin, H.; Shen, Y.; Chen, L. Ambient Air Stable Ni-Rich Layered Oxides Enabled by Hydrophobic Self-Assembled Monolayer. ACS Applied Materials & Interfaces 2020, 12 (1), 1937-1943. DOI: 10.1021/acsami.9b20030.
[34] Mayer, J. K.; Huttner, F.; Heck, C. A.; Steckermeier, D.; von Horstig, M.-W.; Kwade, A. Investigation of Moisture Content, Structural and Electrochemical Properties of Nickel-Rich NCM Based Cathodes Processed at Ambient Atmosphere. Journal of The Electrochemical Society 2022, 169 (6), 060512. DOI: 10.1149/1945-7111/ac7358.
[35] Choi, J.; Dong, L.; Yu, C.-Y.; O'Meara, C.; Lee, E.; Kim, J.-H. Relationship of Chemical Composition and Moisture Sensitivity in LiNiₓMn_{y}Co_{1-x-y}O₂ for Lithium-Ion Batteries. Journal of Electrochemical Energy Conversion and Storage 2021, 18 (4). DOI: 10.1115/1.4051208 (acccessed 10/11/2022).
[36] Lu, Y.; Yuan, W. Superhydrophobic/Superoleophilic and Reinforced Ethyl Cellulose Sponges for Oil/Water Separation: Synergistic Strategies of Cross-linking, Carbon Nanotube Composite, and Nanosilica Modification. ACS Applied Materials & Interfaces 2017, 9 (34), 29167-29176. DOI: 10.1021/acsami.7b09160.
[37] Liu, Y.; Deng, L., Zhang, C.; Chen, K., Feng, F.; Zhang, H. Comparison of Ethyl Cellulose-Gelatin Composite Films Fabricated by Electrospinning Versus Solvent Casting. Journal of Applied Polymer Science 2018, 135 (46), 46824. DOI: 10.1002/app.46824.
[38] Liu, Y.; Li, Y.; Deng, L.; Zou, L.; Feng, F.; Zhang, H. Hydrophobic Ethylcellulose/Gelatin Nanofibers Containing Zinc Oxide Nanoparticles for Antimicrobial Packaging. Journal of Agricultural and Food Chemistry 2018, 66 (36), 9498-9506. DOI: 10.1021/acs. jafc.8b03267.
[39] Secor, E. B.; Dos Santos, M. H.; Wallace, S. G.; Bradshaw, N. P.; Hersam, M. C. Tailoring the Porosity and Microstructure of Printed Graphene Electrodes via Polymer Phase Inversion. The Journal of Physical Chemistry C 2018, 122 (25), 13745-13750. DOI: 10.1021/acs. jpcc.8b00580.
[40] Secor, E. B.; Lim, S.; Zhang, H.; Frisbie, C. D.; Francis, L. F.; Hersam, M. C. Gravure Printing of Graphene for Large-area Flexible Electronics. Advanced Materials 2014, 26 (26), 4533-4538. DOI: 10.1002/adma.201401052.
[41] Secor, E. B.; Ahn, B. Y.; Gao, T. Z.; Lewis, J. A.; Hersam, M. C. Rapid and Versatile Photonic Annealing of Graphene Inks for Flexible Printed Electronics. Advanced Materials 2015, 27 (42), 6683-6688. DOI: 10.1002/adma.201502866.
[42] de Moraes, A. C. M.; Obrzut, J.; Sangwan, V. K.; Downing, J. R.; Chaney, L. E.; Patel, D. K.; Elmquist, R. E.; Hersam, M. C. Elucidating Charge Transport Mechanisms in Cellulose-Stabilized Graphene Inks. Journal of Materials Chemistry C 2020, 8 (43), 15086-15091. DOI: 10.1039/D0TC03309J.
[43] Chen, K.-S.; Xu, R.; Luu, N. S.; Secor, E. B.; Hamamoto, K.; Li, Q.; Kim, S.; Sangwan, V. K.; Balla, I.; Guiney, L. M.; et al. Comprehensive Enhancement of Nanostructured Lithium-Ion Battery Cathode Materials via Conformal Graphene Dispersion. Nano Letters 2017, 17 (4), 2539-2546. DOI: 10.1021/acs.nanolett.7b00274.
[44] Lim, J.-M.; Kim, S.; Luu, N. S.; Downing, J. R.; Tan, M. T. Z.; Park, K.-Y.; Hechter, J. C.; Dravid, V. P.; He, K.; Hersam, M. C. High Volumetric Energy and Power Density Li₂TiSiO₅ Battery Anodes via Graphene Functionalization. Matter 2020, 3 (2), 522-533. DOI: 10.1016/j.matt.2020.07.017.
[45] Luu, N. S.; Lim, J.-M.; Torres-Castanedo, C. G.; Park, K.-Y.; Moazzen, E.; He, K.; Meza, P. E.; Li, W.; Downing, J. R.; Hu, X.; et al. Elucidating and Mitigating High-Voltage Interfacial Chemomechanical Degradation of Nickel-Rich Lithium-Ion Battery Cathodes via Conformal Graphene Coating. ACS Applied Energy Materials 2021, 4 (10), 11069-11079. DOI: 10.1021/acsaem.1c01995.
[46] Park, K.-Y.; Lim, J.-M.; Luu, N. S.; Downing, J. R., Wallace, S. G.; Chaney, L. E.; Yoo, H.; Hyun, W. J.; Kim, H.-U.; Hersam, M. C. Concurrently Approaching Volumetric and Specific Capacity Limits of Lithium Battery Cathodes via Conformal Pickering Emulsion Graphene Coatings. Advanced Energy Materials 2020, 10 (25), 2001216. DOI: 10.1002/aenm.202001216.
[47] Park, K.-Y.; Zhu, Y.; Torres-Castanedo, C. G.; Jung, H. J.; Luu, N. S.; Kahvecioglu, O.; Yoo, Y.; Seo, J.-W. T.; Downing, J. R.; Lim, H.-D.; et al. Elucidating and Mitigating High-Voltage Degradation Cascades in Cobalt-Free LiNiO₂ Lithium-Ion Battery Cathodes. Advanced Materials 2022, 34 (3), 2106402. DOI: 10.1002/adma.202106402.
[48] Secor, E. B.; Prabhumirashi, P. L.; Puntambekar, K.; Geier, M. L.; Hersam, M. C. Inkjet Printing of High Conductivity, Flexible Graphene Patterns. The Journal of Physical Chemistry Letters 2013, 4 (8), 1347-1351. DOI: 10.1021/jz400644c.
[49] Wang, C.; Shao, L.; Guo, X.; Xi, X.; Yang, L.; Huang, C.; Zhou, C.; Zhao, H.; Yin, D.; Wang, Z. Air-Induced Degradation and Electrochemical Regeneration for the Performance of Layered Ni-Rich Cathodes. ACS Applied Materials & Interfaces 2019, 11 (47), 44036-44045. DOI: 10.1021/acsami.9b11452.
[50] Li, J.; Wang, X.; Kong, X.; Yang, H.; Zeng, J.; Zhao, J. Insight into the Kinetic Degradation of Stored Nickel-Rich Layered Cathode Materials for Lithium-Ion Batteries. ACS Sustainable Chemistry & Engineering 2021, 9 (31), 10547-10556. DOI: 10.1021/acssuschemeng.1c02486.
[51] Grenier, A.; Liu, H.; Wiaderek, K. M.; Lebens-Higgins, Z. W.; Borkiewicz, O. J.; Piper, L. F. J.; Chupas, P. J.; Chapman, K. W. Reaction Heterogeneity in LiNi_{0.8}Co_{0.15}Al_{0.05}O₂ Induced by Surface Layer. Chemistry of Materials 2017, 29 (17), 7345-7352. DOI: 10.1021/acs.chemmater.7b02236.
[52] Aryal, S.; Durham, J. L., Lipson, A. L.; Pupek, K. Z.; Kahvecioglu, O. Roles of Mn and Co in Ni-Rich Layered Oxide Cathodes Synthesized Utilizing a Taylor Vortex Reactor. Electrochimica Acta 2021, 391, 138929. DOI: 10.1016/j.electacta.2021.138929.
[53] Rodrigues, M.-T. F.; Gim, J.; Tornheim, A.; Kahvecioglu, O.; Luo, M.; Prado, A. Y. R.; Trask, S. E.; Croy, J.; Abraham, D. P. Concealed Cathode Degradation in Lithium-Ion Cells with a Ni-Rich Oxide. Journal of The Electrochemical Society 2022, 169 (4), 040539. DOI: 10.1149/1945-7111/ac65b7.
[54] M. C. Hersam, et al., Comprehensive Enhancement of Nanostructured Lithium-Ion Battery Cathode Materials via Conformal Graphene Dispersion. (2017) Nano Letters, 17, 4, 2539-2546.
[55] M. C. Hersam, et al., Enhancing nanostructured nickel-rich lithium-ion battery cathodes via surface stabilization. Journal of Vacuum Science & Technology A 38, 063210 (2020).
[56] M. C. Hersam, et al., Elucidating and Mitigating High-Voltage Degradation Cascades in Cobalt-Free LiNiO₂ Lithium-Ion Battery Cathodes. Adv. Mater. 2022, 34, 2106402.
[57] M. C. Hersam, et al., Concurrently Approaching Volumetric and Specific Capacity Limits of Lithium Battery Cathodes via Conformal Pickering Emulsion Graphene Coatings. Adv. Energy Mater.2020, 10, 2001216.
[58] M. C. Hersam, et al., Elucidating and Mitigating High-Voltage Interfacial Chemomechanical Degradation of Nickel-Rich Lithium-Ion Battery Cathodes via Conformal Graphene Coating. ACS Appl. Energy Mater. 2021, 4, 10, 11069-11079.
[59] Z. Zhang, et al., Alleviating the air sensitivity of nickel-rich LiNi0.815Co0.15Al0.35O2 cathode by Zr4+-modification for Li-ion batteries. Ceramics International 45 (2019) 14270-14277 14271.
[60] A. Yu, et al., Enhancing the air stability of LiNi0.6Co0.2Mn0.2O2 cathode through WO₃/Li2WO4 surface modification. Journal of Power Sources 514 (2021) 230605.
[61] K. T. Kee, et al., Hydrophobic Ni-Rich Layered Oxides as Cathode Materials for Lithium-Ion Batteries. ACS Appl. Energy Mater. 2019, 2, 9, 6246-6253.
[62] A. Manthiram, et al., Modified High-Nickel Cathodes with Stable Surface Chemistry Against Ambient Air for Lithium-Ion Batteries. Agnew. Chem. Int. Ed. 2018, 57, 6480-6485.
[63] X. Liu, et al., Improving the cycling and air-storage stability of LiNi0.8Co0.1Mn0.1O2 through integrated surface/interface/doping engineering. J. Mater. Chem. A, 2020, 8, 5234.
[64] J. Zheng, et al., Efficient preservation of surface state of LiNi0.82Co_{0.15}Al0.03O2 through assembly of hydride terminated polydimethylsiloxane. Journal of Power Sources 495 (2021) 229761
[65] L. Chen, et al., Ambient Air Stable Ni-Rich Layered Oxides Enabled by Hydrophobic Self-Assembled Monolayer. ACS Appl. Mater. Interfaces 2020, 12, 1, 1937-1943.
[66] Z. Liu, et al., The effect of Co3O4 & LiCoO2 cladding layer on the high rate and storage property of high nickel material LiNi0.8Co0.15Al0.05O2 by simple one-step wet coating method. Electrochimica Acta 249 (2017) 179-188.
[67] A. Manthiram, et al., Long-Life, Ultrahigh-Nickel Cathodes with Excellent Air Storage Stability for High-Energy Density Lithium-Based Batteries. Chem. Mater. 2020, 32, 17, 7413-7424.
[68] Aruna Zhamu, Jinjun Shi, Guorong Chen, Ming C. Wang, Bor Z. Jang, Graphene-enhanced cathode materials for lithium batteries, U.S. Pat. No. 8,691,441B2, April 8, 2014.
[69] Aruna Zhamu, Bor Z. Jang, Jinjun Shi, Nano graphene reinforced nanocomposite particles for lithium battery electrodes, US20100143798A1, June 10, 2010.
[70] Douglas H. Adamson, Steven Woltornist, Andrey V. Dobrynin, Graphene/graphite polymer composite foam derived from emulsions stabilized by graphene/graphite kinetic trapping, WO2015184155A1, December 3, 2015.
[71] Seth Adrian Miller, Coating a substance with graphene. (2010) U.S. Pat. No. 8,691,335B2, April 8, 2014.
[72] Zhenhua Mao, Bharat Chahar, Carbon-coated silicon particle power as the anode material for lithium ion batteries and the method of making the same. (2003) EP1702375B1, September 20, 2006.

1. A composite for enabling ambient stability of an electrochemical device, comprising:
an active material, wherein individual particles and/or clusters of several particles of the active material are conformally coated with a protective barrier layer.

2. The composite of claim 1, wherein the protective barrier layer is a uniform, hydrophobic coating.

3. The composite of claim 2, wherein the coating comprises graphene.

4. The composite of claim 3, wherein a mass ratio of the active material to said graphene is between about 90:5 and about 99:0.5, preferably about 97.5:2.

5. The composite of claim 3, wherein the coating further comprises multiwalled carbon nanotubes (MWCNTs).

6. The composite of claim 5, wherein a mass ratio of said graphene to said MWCNTs is between about 5:1 and about 10:1, preferably about 8:1.

7. The composite of claim 3, wherein the coating further comprises amorphous carbon with sp²-carbon content.

8. The composite of claim 7, wherein the amorphous carbon is an annealation product of ethyl cellulose.

9. The composite of claim 3, wherein the coating is conformal and free of pinhole defects.

10. The composite of claim 3, wherein the coating mitigates formation of surface carbonates and hydroxides upon a humid CO₂ exposure.

11. The composite of claim 3, wherein the coating protects the active material from degradation during a humid CO₂ exposure and has no deleterious effects on subsequent electrochemical behavior.

12. The composite of claim 1, wherein the active material comprises lithium cobalt oxide, lithium nickel oxide, lithium iron phosphate, lithium manganese oxide, lithium nickel manganese cobalt oxide, lithium nickel cobalt aluminum oxide, lithium-rich oxides, or a combination thereof.

13. The composite of claim 12, wherein the active material comprises nickel-rich lithium oxides.

14. The composite of claim 13, wherein the active material comprises LiNi_{0.8}Co_{0.15}Al_{0.05}O₂ (NCA), LiNiO₂ (LNO), LiMn_{1.5}Ni_{0.5}O₄ (LMNO), LiNiₓMn_{y}Co_{z}O₂ (NMC, where x+y+z=1), LiNi_{0.8}Co_{0.2}O₂ (LNCO), or Li_{w}NiₓMn_{y}Co_{z}O₂ (lithium-rich NMC, where w>1, x+y+z=1).

15. The composite of claim 1, wherein the composite is substantially free of impurities.

16. The composite of claim 1, wherein mass loss behaviors of the composite before and after a humid CO₂ exposure are substantially the same.

17. The composite of claim 1, wherein a surface morphology of the composite during a humid CO₂ exposure is substantially same as a pristine surface morphology of the composite.

18. The composite of claim 1, wherein electrochemical performances of the composite before and after a humid CO₂ exposure are substantially the same.

19. An electrode for an electrochemical device, comprising:
a composite including an active material, wherein individual particles of the active material are conformally coated with a protective barrier layer.

20. The electrode of claim 19, wherein the protective barrier layer is a uniform, hydrophobic coating.

21. The electrode of claim 20, wherein the coating comprises graphene.

22. The electrode of claim 21, wherein a mass ratio of the active material to said graphene is between about 90:5 and about 99:0.5, preferably about 97.5:2.

23. The electrode of claim 21, wherein the coating further comprises multiwalled carbon nanotubes (MWCNTs).

24. The electrode of claim 23, wherein a mass ratio of said graphene to said MWCNTs is between about 5:1 and about 10:1, preferably about 8:1.

25. The electrode of claim 21, wherein the coating further comprises amorphous carbon with sp²-carbon content.

26. The electrode of claim 25, wherein the amorphous carbon is an annealation product of ethyl cellulose.

27. The electrode of claim 21, wherein the coating is conformal and free of pinhole defects.

28. The electrode of claim 21, wherein the coating mitigates formation of surface carbonates and hydroxides upon a humid CO₂ exposure.

29. The electrode of claim 21, wherein the coating protects the active material from degradation during a humid CO₂ exposure and has no deleterious effects on subsequent electrochemical behavior.

30. The electrode of claim 21, wherein the active material comprises lithium cobalt oxide, lithium nickel oxide, lithium iron phosphate, lithium manganese oxide, lithium nickel manganese cobalt oxide, lithium nickel cobalt aluminum oxide, lithium-rich oxides, or a combination thereof.

31. The electrode of claim 30, wherein the active material comprises nickel-rich lithium oxides.

32. The electrode of claim 31, wherein the active material comprises LiNi_{0.8}Co_{0.15}Al_{0.05}O₂ (NCA), LiNiO₂ (LNO), LiMn_{1.5}Ni_{0.5}O₄ (LMNO), LiNiₓMn_{y}Co_{z}O₂ (NMC, where x+y+z=1), LiNi_{0.8}Co_{0.2}O₂ (LNCO), or Li_{w}NiₓMn_{y}Co_{z}O₂ (lithium-rich NMC, where w>1, x+y+z=1).

33. The electrode of claim 32, wherein the active material comprises LNO.

34. The electrode of claim 33, wherein during an activation cycle, the pristine electrode exhibits no evidence of compromised electrochemical behavior, achieving a charge capacity of 253 mAh g⁻¹ and a discharge capacity of 240 mAh g⁻¹ when cycled between 2.8 V and 4.6 V vs. Li/Li⁺ at 0.1 C at 25 °C.

35. The electrode of claim 33, wherein the electrode after a humid CO₂ exposure achieves a charge capacity of 245 mAh g⁻¹ and a discharge capacity of 230 mAh g⁻¹ without a discernable voltage peak at the shoulder near 3.7 V vs. Li/Li⁺ when cycled between 2.8 V and 4.6 V vs. Li/Li⁺ at 0.1 C at 25 °C.

36. The electrode of claim 33, wherein charge transfer resistances of the pristine electrode and the electrode after a humid CO₂ exposure are similar before cycling and after activation.

37. The electrode of claim 19, wherein the composite is substantially free of impurities.

38. The electrode of claim 19, wherein mass loss behaviors of the composite before and after a humid CO₂ exposure are substantially the same.

39. The electrode of claim 19, wherein a surface morphology of the composite during a humid CO₂ exposure is substantially same as a pristine surface morphology of the composite.

40. The electrode of claim 19, wherein electrochemical performances of the composite before and after a humid CO₂ exposure are substantially the same.

41. An electrochemical device, comprising the electrode of any of claim 19.

42. The electrochemical device of claim 41, being a battery.

43. A method for forming a composite enabling ambient stability of an electrochemical device, comprising:
providing an active material; and
coating individual particles of the active material conformally with a protective barrier layer comprising graphene.

44. The method of claim 43, wherein said coating comprises
forming a mixture of the active material, said graphene, multiwalled carbon nanotubes (MWCNTs) and ethyl cellulose; and
thermally annealing the mixture at an annealing temperature in an oxidizing environment to decompose said ethyl cellulose, thereby resulting in the composite having each active material particle coated with a conformal coating comprising said graphene.

45. The method of claim 44, wherein a mass ratio of said graphene to said MWCNTs is s between about 5:1 and 10:1, preferably about 8:1.

46. The method of claim 44, wherein the annealing temperature is in a range of about 150-350 °C, preferably at about 250 °C.

47. The method of claim 44, wherein the conformal coating further comprises amorphous carbon with sp²-carbon content, wherein the amorphous carbon is an annealation product of said ethyl cellulose.

48. The method of claim 44, wherein said forming the mixture comprises dispersing said graphene, said MWCNTs and said EC polymer in a solvent to form a first dispersion.

49. The method of claim 48, wherein the solvent comprises ethanol and anhydrous N-Methyl 2-pyrrolidone (NMP).

50. The method of claim 49, wherein a ratio of said ethanol to said graphene in the dispersion is about 2.5 to 10 mg mL⁻¹, preferably about 5 mg mL⁻¹.

51. The method of claim 49, wherein said forming the mixture further comprises evaporating the ethanol from the first dispersion to form a second dispersion.

52. The method of claim 51, wherein said forming the mixture further comprises adding the active material to the second dispersion and homogeneously incorporating the active material into the second dispersion by centrifugal mixing.

53. The method of claim 52, wherein a mass ratio of the active material to said graphene is between about 90:5 and 99:0.5, preferably about 97.5:2.
